(19) United States
(12) Patent Application Publication
(10) Pub. No.: US 2024/0079152 A1
(43) Pub. Date: Mar. 7, 2024

(54) SELECTIVE TRANSMUTATION OF REACTIVE MOLECULES IN A REACTOR

(71) Applicant: Team Scotia Ltd., Perth & Kinross (GB)

(72) Inventor: Dominic Anwar, PEYIA PAPHOS (CY)

(73) Assignee: Team Scotia Ltd., Perth & Kinross (GB)

(21) Appl. No.: 18/371,452

(22) Filed: Sep. 22, 2023

Related U.S. Application Data
(63) Continuation of application No. 18/353,477, filed on Jul. 17, 2023.
(60) Provisional application No. 63/400,405, filed on Aug. 24, 2022.

(51) Int. Cl. G21D 7/04; G21B 1/15; G21B 1/21

(52) U.S. Cl. CPC G21D 7/04; G21B 1/15; G21B 1/21

(57) ABSTRACT

The invention relates to systems, methods, and devices for imparting energy from dipolar molecules to a circuit in a reactor using electric and magnetic fields. The method as disclosed increases the conductivity of the circuit using dipolar molecules and inducing nuclear fusion to produce heat. The result of the process is to deliver exceptional amounts of controllable energy in an efficient carbon-free manner using an abundant source.

### CROSS-REFERENCE TO RELATED APPLICATIONS

This Non-Provisional patent application claims priority to co-pending U.S. patent application Ser. No. 18/353,477, filed Jul. 17, 2023, which is entitled “SELECTIVE TRANSMUTATION OF REACTIVE MOLECULES IN A REACTOR” with confirmation number 7886 which claims priority to U.S. Provisional Patent Application having the Ser. No. 63/400,405, filed Aug. 24, 2022, which is entitled “SELECTIVE TRANSMUTATION OF REACTIVE MOLECULES (STORM REACTOR)” with confirmation number 5040. U.S. Provisional Patent Application Ser. No. 63/400,405 is hereby incorporated by reference in its entirety.

### FIELD OF THE INVENTION

The invention relates to the concept of imparting energy from reactive molecules to a circuit using a reactor. In particular, the invention relates to an efficient energy generation device, system, and method for increasing the conductivity of the circuit using reactive molecules such as dipolar molecules and inducing nuclear fusion to produce heat in the reactor.

### BACKGROUND OF THE INVENTION

A nuclear reactor is a device used for energy generation through fusion or fission reactions. These reactors are designed to harness nuclear energy in the form of heat and electricity for various purposes such as power generation, chemical reactions, and the like.

Certain limitations associated with conventional fusion reactor systems are that of losses during energy transfer from a circuit to the reactant, which results in an overall reduction in efficiency. Further, the way in which such reactors operate during energy transfer carries inherent safety considerations due to the high temperatures, pressures, and potential risks associated with the process inside the reactor. Also, these are not typically devised for conventional public usage for energy and heat requirements. Further, in conventional reactors, there are additional problems of the scarcity and expense of refining raw materials and the reversibility and containment of nuclear reaction byproducts, which in turn reduces the net energy generated whilst also incurring financial costs.

Thus, there is a need for devices and methods that provide efficient energy generation from an abundant, low-cost raw material, with reduced operational risks. Embodiments of this invention satisfy these needs.

### SUMMARY OF THE INVENTION

This section provides a general summary of the disclosure and is not meant to be a comprehensive disclosure of the full scope of all its features.

In one embodiment, a device is disclosed. This device can be an energy generation device for sequentially transferring nuclear potential energy from dipolar molecules to a circuit. The device comprises a reactor unit, the reactor unit comprising: a first reaction electrode set; a second reaction electrode set; a first chamber electrically connected to the second reaction electrode set;

a second chamber electrically connected to the first chamber; a third chamber electrically connected to the second chamber, the first and the third chambers are flow connected via the second chamber; and an injector for injecting dipolar molecules into the first chamber, a secondary circuit connected to the reactor unit via the first and second reaction electrode sets, the secondary circuit comprising a voltage multiplier rectifier for receiving an input voltage from an AC source and provide a predefined rectified DC voltage output to a DC capacitor; and a primary circuit inductively coupled to the reactor unit via resonant transformers, wherein a discharge of the primary circuit generates a high voltage resonant relationship with the secondary circuit via the resonant transformer, causing discharge of the DC capacitor, thereby establishing a high voltage resonant relationship with vibrating dipolar molecules present between reaction electrodes of the second electrode set, wherein the vibrating dipolar molecules are aligned according to a potential difference between the reaction electrodes of the second electrode set.

In a second embodiment, a method or process is disclosed. This method can be an energy generation method. The method comprised: receiving a predefined volume of dipolar molecules along with air in a reactor unit, under pressure; introducing high voltage into the reactor unit to dissociate a plurality of dipolar molecules of the air-dipolar molecules mixture resulting in heat generation and production of energized ions in a singular nuclear vibration state along with heated air; transferring said generated apparent heat energy of the heated air, to said energized ions, to a circuit over a number of cycles; inducing a condensation phase transition of the air within the reactor unit to provide condensed air, wherein the ions are no-longer re-energized by the air and the circuit develops a higher frequency than the ions; subjecting the non-energized ions to a high frequency electric field to polarize and repolarize the ions, wherein the ions develop a negative temperature and a remaining nuclear potential energy is transferred to the condensed air to provide a positive temperature; and expanding the positive temperature condensed air to create a predefined pressure to fuse the energy depleted ions to generate energy.

In one embodiment, a device is disclosed. This device can be an energy generation device for sequentially transferring nuclear potential energy from dipolar molecules to a circuit. The device comprises a reactor unit, the reactor unit comprising: a first reaction electrode set; a second reaction electrode set; a first chamber electrically connected to the second reaction electrode set; a second chamber electrically connected to the first chamber; a third chamber electrically connected to the second chamber, the first and the third chambers are flow connected via the second chamber; and an injector for injecting dipolar molecules into the first chamber, a secondary circuit connected to the reactor unit via the first and second reaction electrode sets, the secondary circuit comprising a voltage multiplier rectifier for receiving an input voltage from an AC source and provide a predefined rectified DC voltage output to a DC capacitor; and a primary circuit inductively coupled to the reactor unit via resonant transformers, wherein a discharge of the primary circuit generates a high voltage resonant relationship with the secondary circuit via the resonant transformer, causing discharge of the DC capacitor, thereby establishing a high voltage resonant relationship with vibrating dipolar molecules present between reaction electrodes of the second electrode set, wherein the vibrating dipolar molecules are aligned according to a potential difference between the reaction electrodes of the second electrode set.

### BRIEF DESCRIPTION OF DRAWINGS

The invention will be more fully understood, and further advantages will become apparent when reference is had to the following detailed description and the accompanying drawings that set forth illustrative embodiments in which the principles of the invention are utilized, and in which:

FIG. 1 illustrates a circuit diagram of a device for energy generation in accordance with the present invention.

FIG. 2 illustrates a reactor unit of the device in accordance with the present invention.

FIG. 3 illustrates the sub-division of energy of dipolar molecules as hidden and apparent energy, in accordance with the present invention.

FIG. 4 illustrates the polar orientation of a single H2O molecule placed within the reactor unit in accordance with the present invention.

FIG. 5 illustrates the polarity alignment of the plurality of H2O molecules aligned in a series, placed within the reactor unit, in accordance with the present invention.

FIG. 6 illustrates modes of operation of V1 vibrational frequency of dipolar molecules.

FIG. 7 illustrates an embodiment of the polarization for expansion and contraction (vibration) of the dipolar atoms within the reactor unit, in accordance with the present invention.

FIG. 8 illustrates a second embodiment of the polarization for expansion and contraction (vibration) of the dipolar atoms within the reactor unit, in accordance with the present invention.

FIG. 9 illustrates a wave diagram showing constructive and destructive interference periods during OH production in accordance with the present invention.

FIG. 10 illustrates a reactor in a primary circuit showing the fusion of atoms and directions of internal (molecular) and external (circuit) electron current, in accordance with the present invention.

FIG. 11 illustrates an energy embodiment transfer from air to the circuit via OH from the dipolar molecule within the reactor unit, in accordance with the present invention.

FIG. 12 illustrates a second energy embodiment transfer from air to the circuit via OH from the dipolar molecule within the reactor unit, in accordance with the present invention.

FIG. 13 illustrates a graph showing the relationship between mass, volume, and temperature.

FIG. 14 illustrates a reactor inside a reactor unit, showing a first chamber (e-field location), a narrow section or second chamber, and a third chamber located at the opposite end of an air-plug first reaction electrode set.

FIG. 15 illustrates a wave diagram showing amplitudes of summed field wave formed and the DC capacitor resulting in the total value of the summed field wave formed.

FIG. 16 illustrates an expansion mode of a dipolar molecule due to an external magnetic field.

FIG. 17 illustrates an omni-calculator to calculate the specific heat generated by the device of FIG. 1.

FIG. 18 illustrates a calculator for calculating the mixing temperature between air and OH in the first chamber of the reactor unit.

FIG. 19 illustrates a calculator for calculating the specific heat of the gas mixtures in the device.

FIG. 20 illustrates a wave diagram (Oscilloscope graph) of a reaction inside the reactor unit showing first ½ values and fifth ½ values increase the OH volume and decrease in a collision over time.

FIG. 21 illustrates a waveform between time and pressure showing a change in pressure during and following a reaction in the reactor unit.

FIG. 22 illustrates a waveform comparison embodiment between current, voltage, and time for Log 10 transient measurement of current (I) and voltage (V1) from the battery during the reaction and no reaction state.

FIG. 23 illustrates a second waveform comparison embodiment between current, voltage, and time for Log 10 transient measurement of current (I) and voltage (V1) from the battery during the reaction and no reaction state.

FIG. 24 illustrates the installation of the reactor of the present invention for the generation of heat to power a 4-stroke twin cylinder gen-set, in accordance with an embodiment.

FIG. 25 illustrates one of the circuits being fitted to a generator set.

FIG. 26 illustrates a scale of the portable ensemble (circuit and reactor) used in the tests.

FIG. 27 illustrates the calculation of the mass of air and temperature in the chambers of the reactor unit.

FIG. 28 illustrates the phase transition curve of nitrogen in the reactor unit.

FIG. 29 illustrates an experimental test (Test-2) result used to calculate the energy released in accordance with the present invention.

FIG. 30 illustrates an experimental test (Test-5) result used to calculate the energy released in accordance with the present invention.

FIG. 31 illustrates an experimental test (Test-11) result used to calculate the energy released in accordance with the present invention.

FIG. 32 illustrates an experimental test (Test-12) result used to calculate the energy released in accordance with the present invention; and

FIG. 33 illustrates an experimental test (Test-13) result used to calculate the energy released in accordance with the present invention.

### DETAILED DESCRIPTION OF THE INVENTION

The embodiments herein and the various features and advantageous details are explained more fully concerning the non-limiting embodiments illustrated in the accompanying drawings and the following description. Numerous variations, changes, and substitutions may occur to those skilled in the art without departing from the invention, as defined by the subjoined claims. Various alternatives to the embodiments of the present disclosure herein may be employed, and the description should be interpreted as illustrative and not in a limiting sense.

Below is a description of various embodiments of the invention. Before describing selected embodiments of the present disclosure in detail, it is to be understood that the present invention is not limited to any embodiment described herein. The disclosure and description herein are illustrative and explanatory of one or more presently preferred embodiments and variations thereof, and it will be appreciated by those skilled in the art that various changes in the design, organization, means of operation, structures, location, methodology, and use of mechanical equivalents which may be made without departing from the spirit of the invention.

It should also be understood that the drawings are intended to illustrate and disclose presently preferred embodiments to a person skilled in the art. These drawings are not intended to be manufacturing-level drawings or renditions of the final products and may include simplified conceptual views to facilitate understanding or explanation. The relative size and arrangement of the components may differ from that shown and will still operate within the spirit of the invention.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are within the scope of the present claims.

The articles “a” and “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or specified features and may have a singular or plural connotation depending upon the context in which it is used. The adjective “any” means one, some, or all indiscriminately of whatever quantity.

Moreover, it will be understood that various directions such as “upper,” “lower,” “bottom,” “top,” “left,” “right,” “first”, “second” and so forth are made only with respect to explanation in conjunction with the drawings. The inventive components may be oriented differently. For example, during transportation and manufacturing as well as operation. Because many varying and different embodiments may be made within the scope of the concept(s) herein taught, and because many modifications may be made in the embodiments described herein, it is to be understood that the details herein are to be interpreted as illustrative and non-limiting.

In one embodiment, the present invention is modeled, both in theory and in practice, as a device, system, and method to transfer atomic mass energy. The device, as disclosed, herein induces an effectively irreversible atomic state where the transferred mass energy is no longer required by the stable but changed state atoms. Because the atoms are stable in a lower mass state, the excess energy received is now pure output.

Further, the result of the method as disclosed herein is to deliver exceptional amounts of controllable energy in an efficient carbon-free manner using an abundant source. The method as disclosed can potentially provide opportunities to both convert the existing stock or to create a new generation of heat engines and to power anything from a lawnmower to a power station.

Further, the invention is modeled as a system of heat generation using the device along with a control unit. One embodiment includes a control unit that controls various operational parameters of the device including pressure, current/voltage supply, switching, and injection of dipolar molecules into the reactor unit.

The underlying concept that has been developed is for sequentially transferring nuclear potential energy from dipolar molecules to a circuit via constructive and destructive interference electric and electromagnetic fields over a plurality of cycles. The transference of nuclear potential energy from the molecules to the circuit results in the fusion of the molecules and release of mass energy, or heat as an alternative fuel power source in addition to the creation of new matter or elements, depending on the embodiment.

In a preferred embodiment, the device for the sequential transfer of nuclear potential energy from dipolar molecules to a circuit includes a reactor unit having a first reaction electrode set and a second reaction electrode set. Further, the reactor unit includes a first chamber electrically connected to the second reaction electrode set, a second chamber electrically connected to the first chamber, a third chamber electrically connected to the second chamber, the first and the third chambers are flow connected via the second chamber, and an injector for injecting dipolar molecules into the first chamber.

The device further includes a secondary circuit connected to the reactor unit via the first and second reaction electrode sets, a primary circuit inductively coupled to the reactor unit via resonant transformers, the secondary circuit having a voltage multiplier rectifier for receiving an input voltage from an AC source and provide a predefined DC voltage output to a DC capacitor. The discharge of the primary circuit generates a high voltage resonant relationship with the secondary circuit via the resonant transformer, causing discharge of the DC capacitor, which establishes a high voltage resonant relationship with vibrating dipolar molecules present between the reaction electrodes of the second electrode set, which vibrating dipolar molecules are aligned according to the potential difference between the reaction electrodes of the second electrode set.

In an embodiment, the second chamber is shaped as a narrow passage between the first and third chambers. In an embodiment, the second reaction electrode set is a marine type (NGK BUHW) water plug, and the first reaction electrode set may be a marine or J-type electrode, is an air plug type electrode, wherein air-plug type/first reaction electrode is also called as air spark gap and water-plug type/second reaction electrode is also called as water spark gap.

In an embodiment, the reactor unit is preferentially pressurized at a predefined pressure above ambient pressure. In an embodiment, the holding capacitor is connected to one of the reaction electrodes of the first electrode set. In an embodiment, the injector comprises a valve.

In an embodiment, the reactor unit is made of magnetic steel and preferentially magnetic stainless steel. In an embodiment, the third chamber is enclosed by an electrical insulator and preferentially ceramic.

In an embodiment, the primary circuit comprises an AC capacitor, an auto ignition coil, a low-voltage switch, a DC power source, and a third reaction electrode set, wherein the primary circuit induces a very high voltage resonance on the secondary circuit to create a spark at the electrode set and allowing the DC capacitor to discharge. The third reaction electrode set includes an adjustable spark gap switch.

In another aspect, the invention discloses, an energy generation method for sequentially transfer nuclear potential energy from dipolar molecules to a circuit, the method comprising (a) receiving a predefined volume of dipolar molecules along with air in a reactor unit of the device of any one of the above embodiments, under pressure; (b) introducing high voltage into the reactor unit to dissociate some dipolar molecules of the air-dipolar molecules mixture resulting in apparent heat generation and production of energized molecular ions in a single nuclear vibration state vector along with heated air; (c) transferring said generated apparent heat energy of the heated air, to said energized ions, then to a circuit over a number of cycles; (d) inducing a condensation phase transition of the air within the reactor unit to provide condensed air, wherein the ions are no-longer re-energized by the air and the circuit develops a higher frequency than the molecular ions vibration frequency; (e) subjecting the non-energized molecular ions to a high frequency electro-magnetic field to polarize and repolarize the molecular ions, wherein the ions develop a negative temperature and nuclear potential energy is transferred to the condensed air to provide a positive temperature; and (f) expanding the positive temperature condensed air to create a predefined pressure to fuse the energy depleted molecular ions to generate energy.

In an embodiment, the method further includes forcing dipolar constituents of the mixture into an external magnetic field produced by a solenoid coil, resulting in an external pressure causing a series of primary, secondary, and tertiary fusion reactions.

In an embodiment, the dipolar molecules include at least one of water and hydrogen fluoride. In yet another aspect, a system for energy generation is also disclosed. Various objects, features, aspects, and advantages of the inventive subject matter will become more apparent from the following detailed description of preferred embodiments, along with the accompanying drawing figures in which numerals represent like components.

The table given below enlists the components and features of the circuits and reactor unit of the disclosed device:

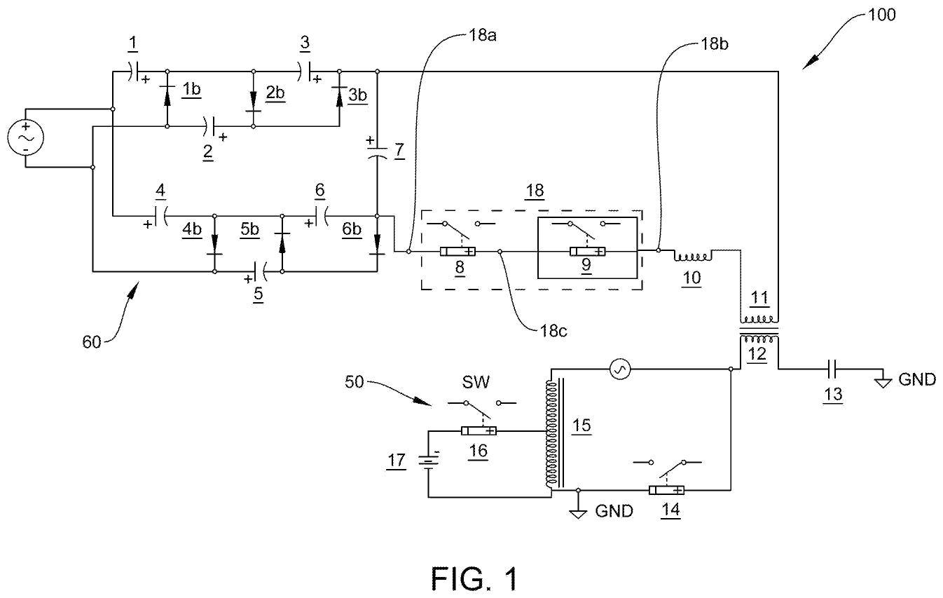

Components of the circuits in FIG. 1:

| S. | Reference | |
|---|---|---|
| No. | numerals | Components/Features |
| 1. | 1 | 11 μf electrolytic capacitor. |
| | 1b | 2 kV diode. |
| 2. | 2 | 8.25 μf electrolytic capacitor. |
| | 2b | 2 kV diode. |
| 3. | 3 | 1 μf electrolytic capacitor. |
| | 3b | 2 kV diode. |
| 4. | 4 | 11 μf electrolytic capacitor. |
| | 4b | 2 kV diode. |
| 5. | 5 | 8.25 μf electrolytic capacitor. |
| | 5b | 2 kV diode. |
| 6. | 6 | 1 μf electrolytic capacitor. |
| 7. | 7 | 7.3 μf electrolytic capacitor. |
| 8. | 8 | 1 mm Air-plug first reaction electrode set |
| | | (NGK BUHW or J-plug) |
| 9. | 9 | Water spark gap (water-plug second reaction electrode |
| | | set) or water spark plug, Marine type (NGK BUHW). |
| 10. | 10 | 50 mH inductor. |
| 11. | 11 | 30 mH (secondary inductance resonant transformer) |
| 12. | 12 | 10 mH (primary inductance resonant transformer) |
| 13. | 13 | 2.2 kV, 0.6 nF, AC capacitor. |
| 14. | 14 | 5 mm (Air) spark gap set (Air-plug third reaction |
| | | electrode set). |
| 15. | 15 | 40 kV Auto ignition coil (generic). |
| 16. | 16 | 12 V switch (manual or automated). |
| 17. | 17 | 12 VDC battery (automotive generic) |
| 18. | 18 | Reactor unit enclosing the Air-plug first reaction |
| | | electrode set |
| 19. | 50 | Primary circuit. |
| 20. | 60 | Secondary circuit. |

Components of the Reactor assembly:

| S. | Reference | |
|---|---|---|
| No. | numerals | Components/Features |
| 1. | 8 | Reaction electrodes-Air-plug first reaction electrode |
| | | set connected to secondary circuit 60. |
| 2. | 19 | Reactor body (magnetic stainless steel is preferred). |
| 3. | 20 | Insulated wire coils (solenoidal wound) or solenoid |
| | | coil ‘magnetic mirror end 1’. |
| 4. | 14 | Third reaction electrode set/ Air spark gap (NGK |
| | | BUHW) location. |
| 5. | 21 | Insulated wire coils (solenoidal wound) or solenoid |
| | | coil ‘magnetic mirror end 2’. |
| 6. | 22 | Ceramic electrical insulator. |
| 7. | 23 | Fused product output. |
| 8. | 24 | Threaded attachment (to the engine combustion |
| | | chamber or sample collector) |
| 9. | 25 | Third Chamber. |
| 10 | 26 | Second Chamber (Narrow section). |
| 11. | 27 | Dipolar molecules (or other dipolar molecules) |
| | | injector and check valve. |
| 12. | 28 | First chamber. |
| 13. | 18a | Solenoid coil to circuit positive connector. |
| 14. | 18b | Air-plug first reaction electrode set to circuit |
| | | negative connector (preferred embodiment) |
| 15. | 18c | Reactor to circuit negative connector (alternative |
| | | arrangement when air gap plug (8) is external to the |
| | | reactor unit) |

According to various embodiments of the present invention, an energy generation device for sequential transfer of nuclear potential energy from dipolar molecules to a circuit is described hereafter that results in the fusion of the molecules and release of mass energy or heat as an alternative fuel power source in addition to the creation of new matter/elements.

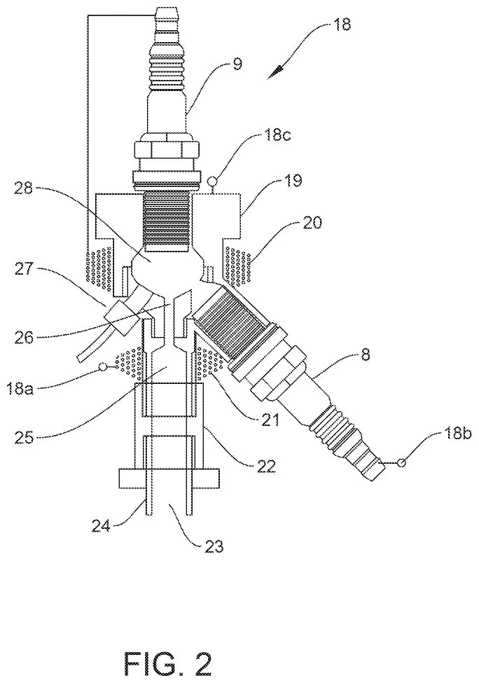

In an aspect, the invention discloses an energy generation device (100) for the sequential transfer of nuclear potential energy from dipolar molecules to a circuit, the device having a reactor unit (18), as shown in FIG. 1, with details shown in FIG. 2. The reactor unit (18) further includes a first reaction electrode set (8), a second reaction electrode set (9), a first chamber (28) electrically connected to the second reaction electrode set (9), a second chamber (26) electrically connected to the first chamber (28), a third chamber (25) electrically connected to the second chamber (26), the first (28) and the third chambers (25) are flow connected via the second chamber (26) and an injector (27) for injecting dipolar molecules into the first chamber (28). The device further includes a secondary circuit (60) connected to the reactor unit (18) via the first and second reaction electrode sets (8, 9), a primary circuit (50) inductively coupled to the reactor unit (18) via resonant transformer (11 and 12), the secondary circuit (60) comprising a voltage multiplier rectifier for receiving an input voltage from an AC source and provide a predefined DC voltage output to a capacitor (7). In accordance with the present invention, the discharge of the primary circuit (50) generates a high voltage resonant relationship with the secondary circuit (60) via the resonant transformer (11 and 12), causing discharge of the DC capacitor (7), which establishes a high voltage resonant relationship with vibrating dipolar molecules present between the second electrode set (9), which molecules are aligned according to the potential difference between the electrodes of the second reaction electrode set (9). Here the term ‘set’ means a pair of electrodes.

In accordance with another aspect of the invention, an energy generation method is disclosed for sequentially transferring nuclear potential energy from dipolar molecules to a circuit, the method includes the following steps:
(a) receiving a predefined volume of dipolar molecules along with the air in a reactor unit (18) of the device (100) of any one of the embodiments under pressure;
(b) introducing high voltage into the reactor unit (18) to dissociate some dipolar molecules of the air-dipolar molecules mixture resulting in apparent heat generation and production of energized molecular ions in a single nuclear vibration state along with heated air;
(c) transferring said generated apparent heat energy of the heated air via the energized molecular ions to a circuit over at least two cycles;
(d) inducing a condensation phase transition of the air within the reactor unit (18) to provide condensed air, wherein the molecular dipolar ions are no longer re-energized by the air, and the circuit develops a higher frequency than the vibration frequency of the molecular ions;
(e) subjecting the non-energized molecular ions to a high-frequency electromagnetic field to polarize and repolarize the dipolar molecular ions, wherein the ions develop a negative temperature and nuclear potential energy is transferred to the condensed air to provide a positive temperature; and
(f) expanding the positive temperature condensed air to create a predefined pressure to fuse the energy-depleted dipolar molecular ions to generate energy.

In an embodiment, the dipolar constituents of the mixture are forced into an external magnetic field produced by a solenoid coil (20, 21), which results in an external pressure causing a series of primary, secondary, and tertiary fusion reactions.

In an embodiment, the dipolar molecules may include water and hydrogen fluoride. In various embodiments of the present invention, a marine type of water plugs second reaction electrode set (9), also called a water spark plug, is arranged within the reactor unit (18) coupled with the first chamber (28), where a small volume of dipolar molecules including H2O is to be placed. The water spark plug or marine-type water plug second reaction electrode set (9), serves as an electrode connected to the DC capacitor (7). In addition, the first reaction electrode set (8), such as the air type plug electrode or air spark plug, is arranged either inside or externally connected to the reactor unit (18), serving as electrodes to be connected to the holding DC capacitor (7) via the resonant transformer (11, 12).

In an embodiment, the reactor unit (18) is pressurized with air up to a certain experimentally obtained pressure (30-110 Pound-force per square inch, PSI (where 1 PSI=0.0689476 bar or 6894.76 Pascal (Pa) as may be used while converting the values throughout the specification hereinbelow) that leads to the conversion of latent heat of water to an apparent heat when the dipolar polar molecules are aligned by the electrodes potential difference (PD) and freedoms of motion are restricted to expansion and contraction vibration (V1) modes. Further, an external electric field is provided by a holding capacitor (7), wherein the different cycles of charging and discharging result in constructive interference with the vibrating dipolar molecules, which have already been polarized by the primary circuit (50) discharge.

In an embodiment, the second chamber (26) of the reactor unit (18) is shaped as a narrow passage between the first (28) and third chamber (25), wherein the third chamber (25) is enclosed by an electrical insulator and preferentially heat resistant ceramic insulator (22). In an embodiment, the reactor unit (18) is made of magnetic steel and preferentially magnetic stainless steel and comprises the dipolar molecule injector (27). The injector (27) includes a one-way check valve.

In an embodiment, the secondary circuit (60) includes capacitors to store charges received from the rectified (to DC) AC source. In a working embodiment, the holding capacitor (7) is connected to one of the reaction electrodes of the first reaction electrode set (8). In an embodiment of the device (100), in the reactor unit (18), the external electric field increases the collision force of H2O molecules with that of pressurized air (at a predefined pressure) (O2) molecules resulting in the production of (OH) hydroxyl ions and heat wherein the heat is stored in a heat sink. Further, a periodic synchronization between the external electric field polarity and the molecular vibration expansion results in the formation of a periodic constructive interference polarity waveform of amplitudes equal to the sum of both energy sources, such as, from the circuit and molecules. Further, during the first half wave vibration cycle, the increase in OH volume results in increased conductance and decreased resistance in the water-plug second reaction electrode set (9).

In an embodiment, the third chamber (25), is connected to the first chamber (28) via a narrow section or second chamber (26), wherein a magnetic field-based transmutation takes place in the third chamber (25). In an embodiment, the volume of hydrogen (H) combines with fluorine in the third chamber (25) to form another dipolar molecule Hydrogen Fluoride (HF), and further release more heat and pressure in the third chamber (25). In one embodiment, multiple reactors are connected in series to generate more heat efficiently. The generated heat per reaction may range from 37.4 Joule to 154.3 Joule (as mentioned in the test results shown in Table 1) or more.

In one embodiment, the method for energy generation from sequentially transferring nuclear potential energy from dipolar molecules to a circuit involves the following steps: Reactor process to create Fluorine 17 (isotope) and to generate heat using the dipolar molecule (H2O) as a resource.

In various embodiments, the process comprises placing a small volume of a dipolar molecule such as water (including tap, bottled, etc.) in the type of droplets between the second reaction electrode set (9) (FIG. 2) of a marine type water spark plug also called as water-plug of the reactor unit (18), method of water injection include, but are not limited to: via injection (as shown in FIG. 2) or manual incorporation. Further, the reactor unit (18) is then preferentially pressurized with air to a pressure of (but not limited to) the range of 30-110 PSI (gauge pressure). In an embodiment, the air pressure is provided by either piston or turbine in heat engine applications. In chemical or element creation applications, the air pressure is obtained by attaching the reactor unit (18) to an air compressor.

In various embodiments, a secondary circuit (60) (DC circuit) is charged by a main Alternating Current (AC) power supply (for example, 240 VAC-Volts Alternating Current). The AC input voltage is stepped up via a voltage multiplier rectifier over multiple stages and converted to Direct Current (DC). Depending on the input voltage, number of stages, and capacitance, the voltage potential at the holding cap (FIGS. 1-7) is preferably at least 700 VDC, more preferably between 700 to 2000 VDC, and most preferably between 1000 to 2000 VDC, while its capacitance is preferably at least 10 μf and more preferably between 10 μf to 500 μf. The input energy stored may range from 60 to 77 or more joules. Further, during the charging of the holding cap, the secondary circuit (60) may be broken by the resistance provided by the air in the air spark plug/ air-plug first reaction electrode set (8), which may also be of a marine or J-type electrode type design.

In various embodiments, a high voltage (HV) primary circuit (50) is powered by a battery of 12 VDC or more and utilizes an autotransformer (as shown in FIG. 1) to provide a voltage of 40 kV or more. The triggering of the HV circuit may be achieved manually or by connecting to an existing engine Electronic Control Unit (ECU) ignition triggering device or signal generator, for example, as in the case of piston engines.

In various embodiments, both the primary HV and secondary circuits (60) contain LCR (inductance, capacitance, and resistance) components. Therefore, triggering the primary circuit (50) generates a high voltage resonant relationship with the secondary circuit (60) via the resonant transformer (11, 12). Preferentially, the resonant frequency is in the range of 10 to 100 MHz, and the induced voltage on the secondary circuits (60) is in the range of 30 to 100 kV (or more). Thus, the triggering of the HV primary circuit (50) generates a sufficiently high voltage in the secondary circuit (60) that results in the ionization of the dipolar molecules present between the second electrodes set (9) and the ionization of the air molecules present between the first electrode set (8).

In one embodiment, following ionization and provision of electrons to the circuit, the DC capacitor can discharge and make the secondary circuit.

The various operational parameters such as current or voltage supply, injection of dipolar molecules into the reactor unit, pressure, and temperature may be controlled by a control unit in a working embodiment of a system incorporating the device (100). The control unit may include a microcontroller or a programmable logic circuit in conjunction with certain sensors deployed in the reactor unit to measure various physical parameters and provide the readings to a computing device in real-time. This can be accomplished via means known by persons skilled in the art with the benefit of the disclosures herein.

In various embodiments, the relationship between LCR components is such that the output (voltage and frequency) may be changed if the value of one of the LCR components is altered.

This adjustability is further compounded by the coupling of one resonant circuit (for example, the primary HV (50)) with another resonant circuit (for example, the secondary DC (60)). For easier and quicker tuning, the system may utilize an oscilloscope (appropriately scaled to 1 MV or more) to measure the voltage and frequency using components close to the values described, then adjust a single component (for example, secondary inductance (11)), until the resonant frequency and (output) voltage during the reaction is optimized.

In accordance with various embodiments, the preferred location of the air spark plug, or air plug, is inside the reactor unit (18) (FIG. 1). However, it may be placed externally as an ideally adjustable air spark gap, air spark plug, air plug (14), or combinations thereof, as shown in the circuit schematic of FIG. 1.

The introduction of a spark into the reactor unit (18) dissociates dipolar molecules of the air-dipolar molecules mixture resulting in apparent heat generation and production of energized hydroxyl ions in a single nuclear vibration state along with heated air. Further, the generated apparent heat energy of the heated air is transferred via the energized hydroxyl ions to a circuit over at least two cycles. Furthermore, a condensation phase transition of the air within the reactor unit (18) is induced to provide condensed air, wherein the hydroxyl ions are no longer re-energized by the air, and the circuit develops a higher frequency than the hydroxyl ions vibration. The non-energized hydroxyl ions are then subjected to a high-frequency electromagnetic field to polarize and repolarize the hydroxyl ions, wherein the hydroxyl ions develop a negative temperature and nuclear potential energy is transferred to the condensed air to provide a positive temperature. The positive temperature condensed air is then expanded to create a predefined pressure to fuse the energy-depleted hydroxyl ions to generate high kinetic energy gases.

### Thermodynamic/Mechanical Aspect

In one embodiment, the process produces a product by a fusion reaction of the oxygen component (O) and single hydrogen (H) atoms originating from the H2O droplet injected using a dipolar molecule injector or check valve (27) or placed between the water-plug second reaction electrodes (9). The process is divided into Five parts (A):
A. The internal energy (U) of H2O at an ambient temperature (for example, approximately 20° C.) is conserved in 9 degrees of freedom to move, and only a small proportion is expressed as apparent energy. Apparent Energy means the simple product of voltage and current in an alternating current (AC) system, without regard for the presence of reactive energy due to the phase differences between voltage and current at any given time. Apparent energy=Active energy+Reactive energy. The remaining hidden portion of the internal energy is transformed to apparent heat when the freedom of movement is reduced and conserved in remaining vibration 1 (V1) via the imposition of the circuit's electric field (external e-field) on the polar molecules. The H₂O temperature of its remaining freedom of movement increases while the temperature in the suppressed freedoms of movement is decreased.
B. The frequency of H₂O molecules remaining vibration is initially greater than the frequency of the circuit. Periodically the circuit e-field is increased when the remaining vibration polarization forms an internal polar e-field that has a constructive interference relationship with the external e-field of the circuit. The increased amplitude (temperature) during constructive vibrations results in collisions with entrapped O₂ gas in the water droplet, which produces OH+H and O₁+O₁. Such as, over one or more V1 vibrations, OH is produced from the collisions, as the resistance caused by O₂ is reduced.
C. The circuit e-field maintains a restriction in OH freedoms of movement, and internal energy (U) is conserved in the remaining V1 freedom. The temperature of the OH volume's remaining freedom of movement is increased while the temperature in the suppressed freedoms of movement is reduced. Over at least two V1 vibration cycles, the circuit voltage and frequency are increased as the OH transfers energy to the circuit, and the OH temperature is reduced following energy transfer. The warmer ambient air, initially 20° C. (68° F.), equalizes temperature with the cooler OH. As the OH is re-heated by the air, energy continues to be transferred to the circuit via the OH vibration.
D. At a threshold temperature, the air condenses to liquid, and the OH continues to transfer its internal energy (U) to the circuit via vibration but is no longer re-heated by the air, and the frequency of the OH vibration decreases. When the OH frequency is lower than the circuit frequency, the final freedom of OH movement is arrested. The OH develops a negative temperature and transfers the remaining internal nuclear energy to the condensed air. As the air is superheated and expands, pressure is exerted on the nuclear energy (so coulomb barrier) depleted OH, which fuses to Fluorine.
E. The heat and pressure produced by the primary fusion events results in high kinetic energy gases. The dipolar constituents (for example, HF) are forced into an external magnetic field produced by a solenoid coil (20, 21). The critical thermodynamic event of negative temperature releasing internal energy resulting in an external pressure that causes fusion is repeated via a magnetic field method embodiment in the same reaction causing a series of primary, secondary, and tertiary fusion reactions.

Internal energy (U): In this section, the relationship between the internal energy of a system and the degree of freedom of H2O is discussed using the equipartition theorem:

Equipartition theorem:

$$U = ( E ) = N \frac{{k}_{B} T}{2}$$

In the classical limit of statistical mechanics, at thermodynamic equilibrium, the internal energy of a system of N quadratic and independent degrees of freedom is:

$$Cp = {C}_{V}^{Vib} + {C}_{V}^{Rot} + {C}_{V}^{Tr} = \frac{18}{2} R$$

By the equipartition theorem, internal energy per mole of gas is equal to cv T, where T is the temperature in kelvins and the specific heat at constant volume is cv=(f)(R/2). Where R is a universal gas constant and the value of R=8.314 J/(K mol), and “f” is the number of thermodynamic (quadratic) degrees of freedom, counting the number of ways in which energy can occur. To correlate the specific heat capacity (Cₚ) of H₂O with its freedom of motion, all H₂O molecular vibrations, rotations, and translations are accounted for. In agreement with the reference material, the specific heat capacity of water is the product of 9 degrees of freedom.

Again, referring to FIG. 1, the reactor unit (18) includes first and second reaction electrode sets (8, 9). The primary and secondary circuits (50, 60) are connected to the reactor unit (18) via the first reaction electrode set (8), which is internally connected, and the second reaction electrode set (9), which is externally connected to the secondary circuit (60). The secondary circuit (60) disclosed herein comprises multiple diodes and capacitor connected to form a voltage multiplier and is adapted to receive an input voltage from an AC (alternate current) power source to provide a predefined DC voltage output to the second reaction electrode set (9). Further, the first reaction electrode set (8) stops the circuit from ‘self’ discharging whilst the rectified (secondary circuit) circuit Holding capacitor (7) is being charged such as the air in the electrode gap provides resistance which stops the flow of ‘charging’ current across it. On the activation of the high voltage auto ignition coil (15) of the primary circuit (50), the induced voltage on the secondary circuit (60) causes a spark generation across the electrodes (overcoming the air resistance) and effectively ‘closes’ the switch, to allow the DC capacitor to discharge across the electrode sets (8, 9). In an embodiment, the device includes a third reaction electrode set (14), which is also a high-voltage spark gap switch. On the activation of the high-voltage auto ignition coil (15) by a user (via switch 16), a high-voltage current flows through the resonant transformer (11 and 12), and the AC capacitor (13) are charged. The AC capacitor (13) has extremely low capacitance, so once the capacitor (13) is charged, the high voltage current creates a spark at the third reaction electrode set (14), which allows the AC capacitor (13) to discharge. This results in high voltage current flow through the resonant transformer (11 and 12) in one direction (during AC capacitor (13) charging) and then flows in an opposite direction (through the resonant transformer) during the AC capacitor (13) discharging. This event creates a very high voltage ‘resonance’ induced on the secondary circuit (60), creating a spark at electrode set (8), allowing the DC capacitor to discharge. The device is disclosed in more detail in FIG. 2.

FIG. 2 illustrates the reactor unit (18) of the device (100) in greater detail. The reactor unit (18) comprises a first chamber (28) electrically connected to the second reaction electrode set (9); a second chamber (26) electrically connected to the first chamber (28); a third chamber (25) electrically connected to the second chamber (26), wherein the first (28) and the third chambers (25) are fluidly connected via the second chamber (26). Further, the reactor comprises an injector (27) for injecting dipolar molecules into the first chamber (28), wherein the discharge of the primary circuit (50) generates a high voltage resonant relationship with the secondary circuit (60) via the resonant transformer (11 and 12), causing discharge of the DC capacitor, which establishes a high voltage resonant relationship with the vibrating dipolar molecules present between the second electrode set (9) which are aligned according to the potential difference between the second reaction electrode set (9).

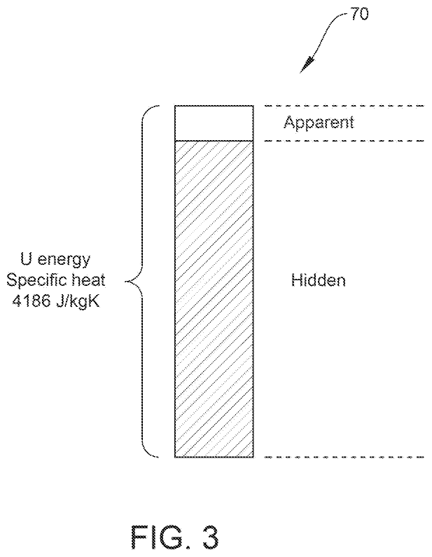

FIG. 3 illustrates the sub-division of energy of the H2O dipolar molecule as hidden and apparent energy or representation of energy distribution in naturally occurring matter (70), in accordance with the present invention. As visualized, only a small percentage of the energy stored in H2O is apparent as temperature, while the majority of the energy is normally hidden and expressed (not necessarily equally) in all the degrees of freedom. Only the movements of the molecules which can transfer energy, for example, to the neighboring molecules, contribute to the temperature when water is heated. For example, to heat the volume of water by 1K (or 1° C.), the internal energy (U) must be increased. When energy is added, it is subdivided between hidden and apparent. If water is taken as an example of a dipolar molecule, only (approx.) 11% of the energy input contributes to an increase in its temperature. In this case, water existing at 293.15 K (20° C.) by virtue of the sun having heated it from ice is an energy repository.

The following reactions, as discussed below, take place inside the reactor:

### Process A: Transformation of Internal Energy (U) to Apparent Energy

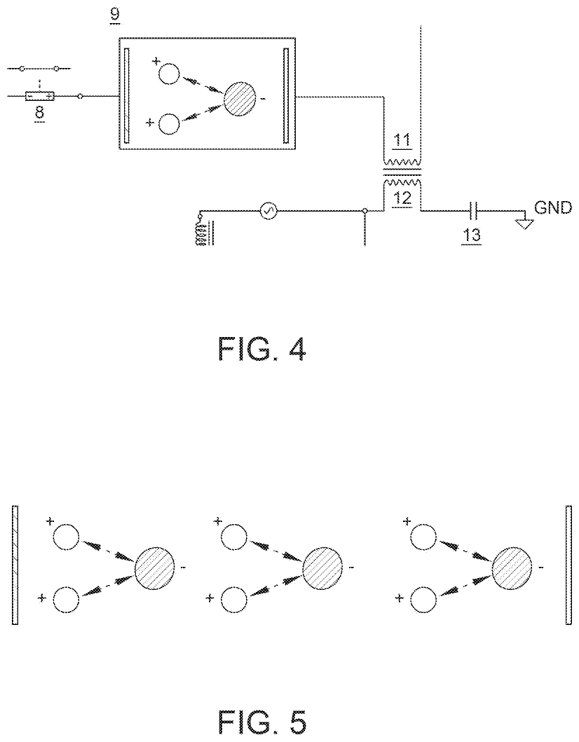

FIG. 4 illustrates the polar orientation of a single H2O molecule placed between the water-plug second reaction electrode set (9) within the reactor unit (18), in accordance with the present invention. This figure shows the alignment of the single H2O molecule between the water-plug second reaction electrode set (9) and is in accordance with the water-plug second reaction electrode set (9) polarity, wherein +ve circles represent hydrogen, and the −ve circle represents oxygen. The movement of the H atoms away from the O atoms (during vibration expansion) is represented by the black arrows. The figure further shows the placement of 30 mH (secondary inductance resonant transformer) (11), 10 mH (primary inductance resonant transformer) (12), and 2.2kV, 0.6 nF, AC capacitor (13). The Potential Difference (PD) between the electrodes causes alignment of the entire 293.15 K H2O volume, where the more +ve Hydrogen atoms are attracted to the −ve plate of the electrode, and the more −ve oxygen atoms are attracted to the +ve plate of the electrodes.

Further, the 9 degrees of freedom of H2O is reduced to 1 and is known as V1 symmetrical stretching. Within that remaining degree of freedom, the energy previously hidden as latent heat becomes apparent, and the temperature of the V1 mode increases by 9 times, such as (9×20° C.=180° C.=453.15 K). However, no energy is transferred from the circuit yet because the alignment is a response to the electrode's potential energy. To produce current to transfer energy to the H2O, the resistance provided by the entrapped O2 in the water and air in the Air-plug first reaction electrode set (8) is exceeded by the PD (voltage) between the electrode plates.

FIG. 5 illustrates the polarity alignment of a plurality of H2O molecules aligned in a series and placed within the reactor unit (18), wherein black arrows (between O and H) represent the movement of O relative to H. It further illustrates that by the same process that the batteries wired in series result in a voltage equal to the sum of the individual voltages, the alignment of many H2O molecules are disclosed for the present system, each with individual internal potential differences results in a summed voltage at the electrode plates. The voltage increase is also a product of the natural tendency of a system containing many bodies to modify their frequency phases to a system-wide unified frequency.

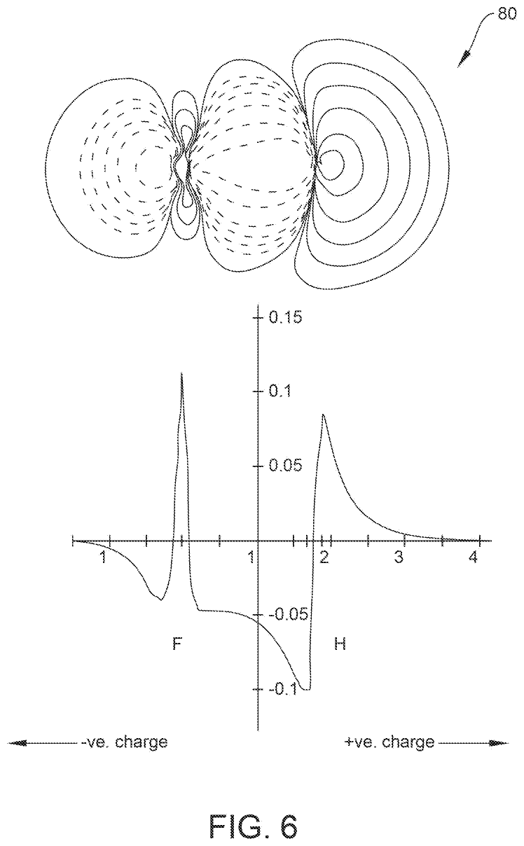

FIG. 6 illustrates the modes of operation (80) of the V1 vibrational frequency of dipolar molecules, wherein the V1 vibrational frequency has two modes of operation—‘expansion’ and ‘contraction.’ Wherein during expansion, the inter-nuclear distance in each dipolar molecule increases, and during contraction, the inter-nuclear distance decreases. It further shows charge distribution in HF molecules and the location and magnitude of the negative charge (polar electrons) between the nuclei. The electron shielding of the nuclei (from each other) in this configuration facilitates molecular vibration contractions.

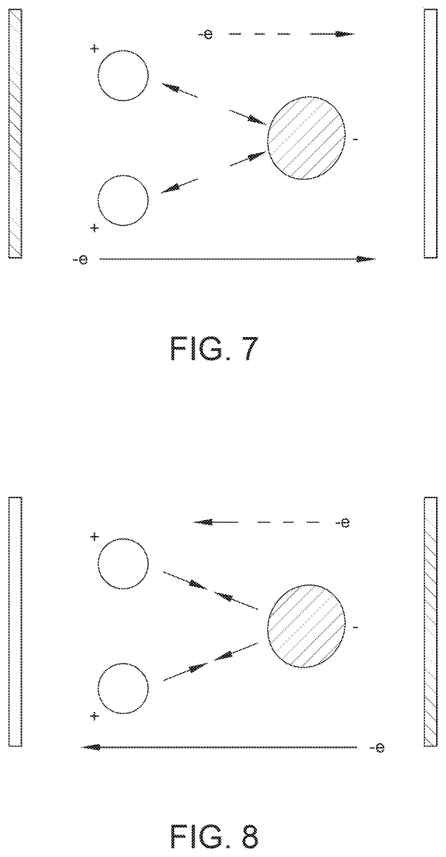

FIGS. 7 and 8 illustrate the expansion and contraction (vibration) of the dipolar molecule (H2O) within the reactor unit (18), carrying relatively positive and negative charges corresponding with the movement or migration of electrons. The dashed line arrow (−e) in the Figure represents the movement of polar electrons (required for molecular expansion) towards the right of the O nucleus (attracted to the +ve electrode plate). Further, continuous line (−e) represents the circuit's electron current between the electrodes. FIG. 7 represents ‘constructive interference’ during an expansion mode of vibration. The same conventions are repeated in FIG. 8 to show constructive interference during a contraction mode of vibration. Similarly, Hydrogen Fluoride (HF) is also a molecule composed of relatively positive and negative atoms. Although the absolute charges are different, the polarization process is similar. Further, V1 molecular expansion requires the polar electrons to move to the oxygen end pole. The de-shielding of the net positive nuclear charges causes the atoms to repel each other and increase or expand the inter-nuclear distance. By the same mechanism, the contraction is a result of the migration of the electrons from the oxygen nucleus pole to a region midway between the atoms, where the electron's net −ve charges counter the nuclear positive charges, so allowing the inter-nuclear distance to reduce (contraction mode).

Further, the resulting movement of positive and negative charges in space during vibrations is the definition of an electric field, which results in the generation of internal electromagnetic fields during both V1 vibrational movement modes. Further, using V1 expansion as an example, firstly, the polar electrons are moved to create an internal electric field. Secondly, the nuclei can move apart to create another electric field. The electric field caused by nuclear movement (expansion), being a response, cannot precede the electric field caused by the polarization of the electrons.

### Process B: Production of Hydroxyl Group (OH)

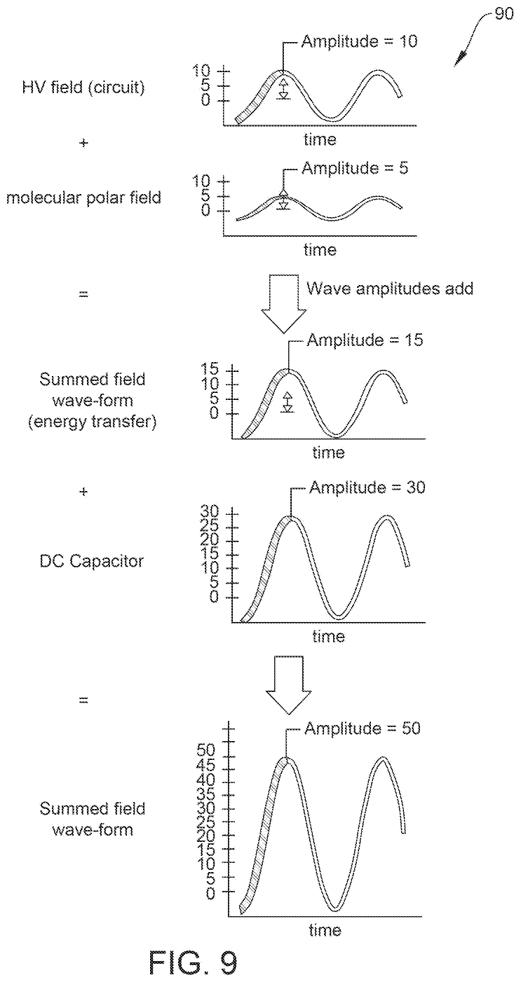

In accordance with various embodiments of the invention, when the molecules are located between the circuit electrodes, their internal electric field, which is created by the polarization of electrons and movement of nuclei, develops a constructive or destructive relationship with the circuit's electric field. The constructive periods are represented in waveforms (90), as depicted in FIG. 9.

FIG. 9 illustrates a wave diagram (90) showing that during constructive periods. As shown, the total electric field becomes a value equal to the sum of the internal (molecules) polarization current and external (circuit) current. Further, the constructive wave made by the reactant molecules is equal to their internal energy, ‘U’ (conserved in that remaining motion).

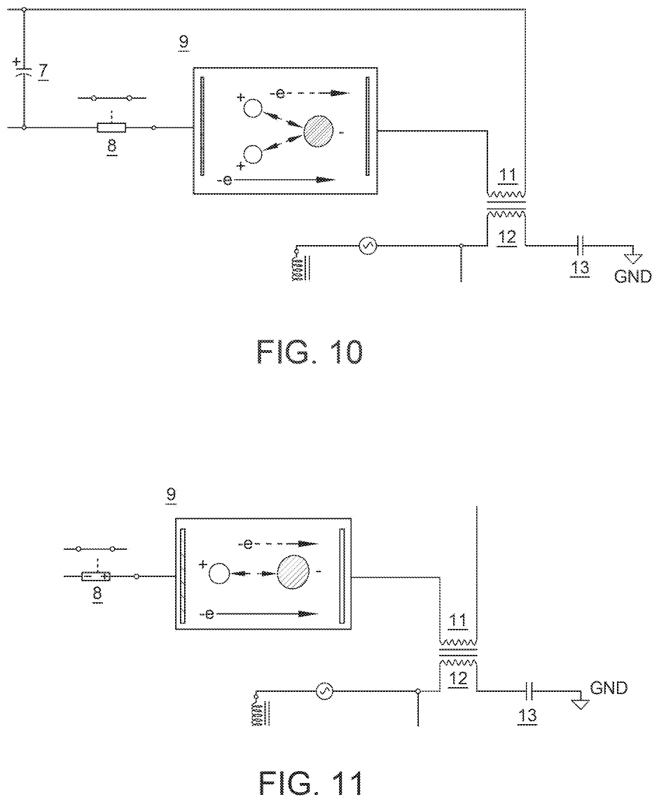

FIG. 10 illustrates a circuit diagram showing the application of internal (molecular) electron current and external (circuit) electron current where the high voltage first reaction electrode set (8) or air spark gap is enclosed within the reactor unit (18), in accordance with the preferred embodiment of the present invention to improve the reaction efficiency. Further, in other working embodiments, it may not be enclosed within the reactor unit (18). Further, showing that if the increased electric field (potential difference) is more than the resistance (R) at the air-plug first reaction electrode set (8) and at the water-plug second reaction electrode set (9), then the DC capacitor can discharge its stored charge Q (Q=Capacitance×Voltage). However, when a DC capacitor is charged to, e.g., 2 kV (tests conducted between 700 V and 2.5 kV), its discharge current is equal to the summed voltage/induced voltage across the reaction electrodes set (8), which may be 200 kV. This allows for massively increasing the power of the discharge by almost 10-100 times in one or more preferred embodiments, thereby increasing energy transferred over less time.

The relationship between voltage, current, and resistance is described by Ohm's law having the equation, I=V/R, which shows that the current I flow through a circuit is directly proportional to the voltage V and inversely proportional to the resistance R. In other words, by increasing the voltage or reducing the resistance, the current increases. In context, this means during the constructive expansion, the H2O gains energy as its V1 temperature (amplitude) is increased equal to the gain in current-voltage (energy).

There are two possible outcomes: First, no work is done between the electrodes.

If the constructive current does no work between the electrodes, then the resonant transformers (11, 12) and inductor (10) become energized. In essence, energy, including the H2O's latent heat, is transferred to the transformer and inductor. Second, work is done between the electrodes.

At ambient pressure and temperature, the H2O droplet will contain O2. (If the chamber of the reactor was pressurized above ambient pressure before the reaction, the H2O droplet would contain more O2). While O2 exists in the H2O droplet, the outcome of the gain in the electric field (current voltage) during molecular V1 expansion is collisions between the H2O and the entrapped O2 as ‘work done.’ The collision energy (force/distance) causes dissociation of the O2 to O1+O1 and partial dissociation of the H2O to OH+H. Then a secondary event of H+O - - - >OH bond formation takes place.

The following sequence of events thus far takes place in the reactor unit (18) of the device (100) in accordance with the invention:
1. Freedom of movement of H₂O was reduced to 1, and its internal energy (U) was transformed to apparent heat energy as increased amplitude V1 vibrations (temperature) on the remaining axis of movement.
2. The vibration expansion mode of the entire H₂O volume creates multiple internal e-fields.
3. The internal e-fields of the entire H₂O volume in series produce an additive voltage between the electrodes.
4. The circuit voltage combines with the H₂O volume's internal electric field voltage sum, so the voltage across the electrode plates exceeds the resistance of the entrapped O₂ (and air plug).
5. The DC capacitor releases its charge (Q=Capacitance x Voltage) as a current (conserved as increased expansion vibration) flows between the plates.
6. The energy conserved in the constructive e-field does work via collision-induced (partial) dissociation of H₂O and dissociation of O₂.
7. The latent heat of the H₂O is now conserved as a volume of OH.

### Process C: Energy Transfer from Air to OH, then OH to Circuit Embodiment

The circuit frequency (successful tests conducted between 10-25 Mhz depending on LCR values) is lower than the constrained V1 vibration frequencies of OH and H2O molecules. This mismatch means the electrodes remain polarized during multiple natural expansion-contraction cycles, with the result that expansion-contraction cycles at the natural frequency are suppressed. As discussed, expansion modes initially involve collisions between H2O and O2 molecules resulting in the formation of OH product, then the OH is aligned between the electrodes as its freedom of movement is reduced from 6 to 1 again on the X-axis between the electrodes.

FIG. 11 illustrates a circuit diagram for energy transfer from air to the circuit via OH from the dipolar molecule within the reactor unit (18) of the device (100) and further shows that at minimum inter-nuclear (O—H) distance, polar electrons polarize in accordance with vibration expansion. In resonance, the e-field summed constructive current (now the sum of the OH series polarization+the circuit energy) no longer does work between the electrodes because the entrapped O2 volume is consumed in the formation of the OH volume. The outcome of the internal polarization current having a constructive relationship with the external e-field is an increase in the voltage across the water-plug second reaction electrodes set (9) and through the resonant transformer (11). Having transferred energy to the transformer, the OH is cooled as the transformer produces a voltage in opposition to the change in current, so it instigates a contraction mode.

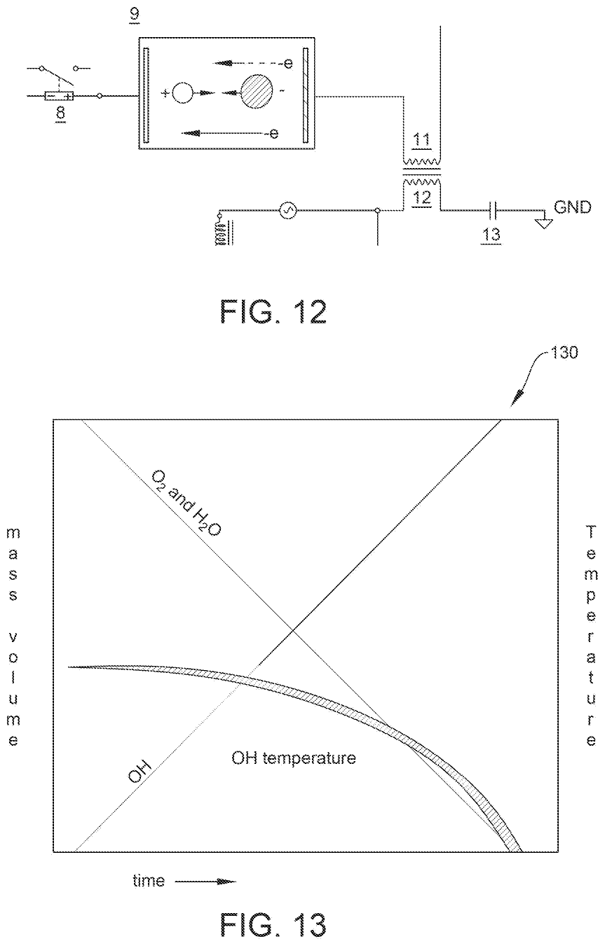

FIG. 12 illustrates a circuit diagram for energy transfer from air to the circuit via OH from the dipolar molecule within the reactor unit (18) of the device (100) and further shows a constructive interference period (during contraction mode). In resonance, as with the previous constructive expansion mode, the internal polarization current during contraction has a constructive relationship with the external e-field. The voltage of the current through the transformer is increased, and having transferred energy to the transformer, the OH is cooled again as the transformer produces a voltage in opposition to the change in current, so it instigates an expansion mode.

Recalling that the OH volume is only expressing ⅙th of its temperature to the air (which exists on axes other than V1), following work done during vibration modes, the air attempts to equalize temperature with the OH. The warmer air transfer heat to the colder OH. But because that energy can only be conserved in increased X-axis V1 motion, from the air's perspective, the OH is not increasing its temperature, so the air continues to transfer its heat. The OH volume has become a heat sink to the air's heat energy, then a conduit for transferring that energy to the circuit via the transformer.

FIG. 13 illustrates a graph (130) of water and air, showing events from the air's perspective. As the OH volume increases over time in equilibrium with the reduction in O2 and H2O volume (and the number of collisions in the e-field is reduced), the temperature and pressure of the molecules in the e-field decrease on all axes except the X axis. Further, the Heat (energy) is transferred from the air to the e-field OH and conserved as increased motion (temperature) on the X-axis.

Once the air's heat is conserved in the OH, as increased internal potential energy, the constructive interference during OH polarization results in a circuit current of greater voltage. As the inductor (10) and resonant transformer (11, 12) become energized more by the increased voltage current, the back electromotive force (EMF) produced is increased both in terms of magnitude (V) and frequency, such as, the greater the rate of current change, the sooner the back EMF is produced relative to the energy depleted OH vibration movement.

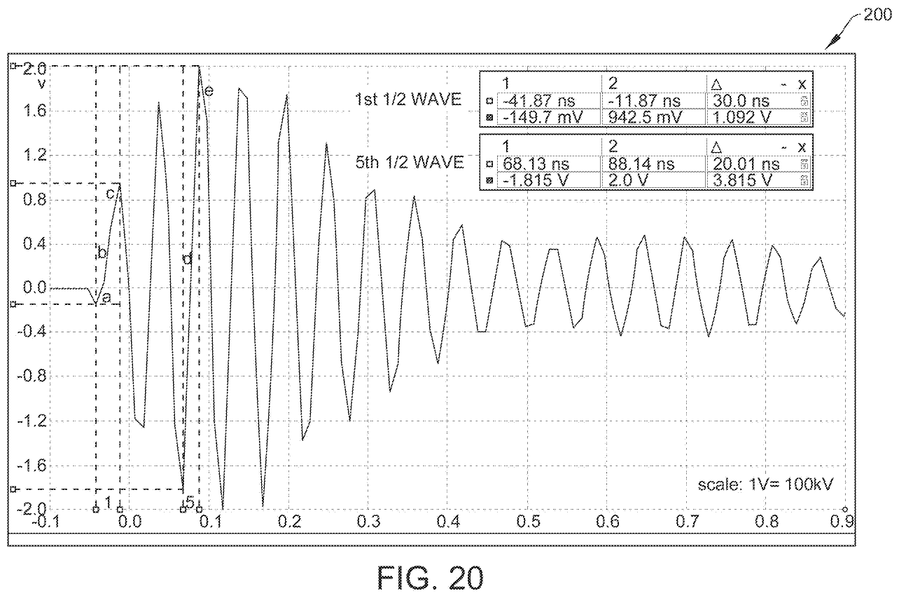

In various embodiments of the invention, the transition between collisions and non-collisions in the water-plug second reaction electrode set (9) occurs over two to three circuit ½ wave cycles involving multiple OH (V1) expansion-contraction events (as shown in the Oscilloscope graph in FIG. 20). The air sparkplug (8)/air-plug gap resistance and resistance caused by O2 in the water plug (9) determines the voltage necessary prior to the current flowing across electrodes (8 and 9). Greater resistance requires (and results in) more heat to be transferred from the air to the OH.

In various embodiments of the invention, the relationship between the circuit, the OH, and the air over a full OH vibration cycle is disclosed to explain why the air is cooled, wherein during constructive expansion and constructive contraction polarization, the circuit current is increased. This is an example of transference of the molecules' potential energy to the circuit's potential energy because when the circuit current is increased by the molecule's internal polar current, the circuit's (inductor) potential energy (voltage) is increased.

When current flows to an inductor, the inductor develops a voltage in opposition to the direction of the current as the product of energy transfer. In this process, energy is transferred to the inductor, then conserved as an induced voltage force. The induced voltage (in opposition to the direction of current) is dependent on the magnitude of the current (voltage) ‘attempting’ to flow through it (which is equal to the constructive sum of the circuit+polar current), the number of coil turns (inductance) and the rate of change in the current (frequency).

Back emf in volts: V=−L×di/dt
L=self-inductance
di/dt=rate of current change. (i=current and t=time)

When the OH has lost potential energy, its temperature is reduced, so the air tries to reheat it. The following movement mode commences with the circuit having gained potential energy, so the external e-field current is increased equal to the gain in transformer (inductor) voltage, the OH has regained some of its lost energy from the air and the air is cooled. Further, the constructive summed value current is greater because the air's heat is now conserved in the circuit's contribution to the summed constructive value. The product of each cycle results in a gain in (a) circuit potential and (b) a reduction in the air's temperature.

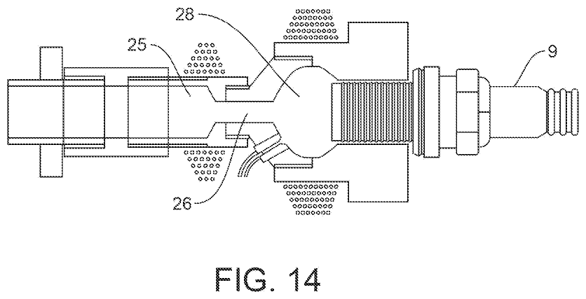

FIG. 14 illustrates a reactor unit (18) construction, which shows that the air in a first chamber (28) (e-field location) is partially isolated from the remaining air spaces of the reactor via a narrow section or second chamber (26). Further, there is also a third chamber (25) of the reactor located at the opposite end of a spark plug to allow an additional third reaction. As shown in the ‘calculations’ section, because of the low heat capacity of air, the equalization in temperature between the small air volume in the first chamber (28) (at 293.15 Kelvin) and the OH volume (continuously transferring heat energy to the circuit) results in the air achieving condensation temperature in that chamber. It is to be noted here that the flow restrictions imposed by the narrow section, or second chamber (26) serve to reduce the rate at which the first chamber (28) can equalize temperature and pressure with the remaining air volume, which includes the combustion chamber or sensor location (not shown).

Neither N2 (molecular Nitrogen) nor O2 (molecular Oxygen), forming most of the ambient air volume, are polar molecules. Their phase spaces are not bounded, and their U energy is conserved as normal such as only a small proportion is apparent heat and a large proportion is a latent heat (also called phase energy). Apparent heat, also referred to as the specific heat capacity c, is the amount of energy it takes to raise, or lower, the temperature of one kg of material by 1 degree Kelvin or Celsius. The latent heat is the heat released or absorbed per unit mass by a system in a reversible isobaric-isothermal change of phase.

Further, the body of the water-spark plug (9) (at approx. 20° C.) is also warmer than the V1 restricted OH at its interface axis and is also disposed to transfer heat to the OH. If the metallic (ferrous steel) cathode surface area becomes oxidized (FeO) as naturally occurs rapidly over several reaction discharges due to the proliferation of atomic oxygen, it was found that the rust provides sufficient heat insulation. Conduction of heat via a ceramic electrical insulator (22) portion of the water-spark plug (9) surface area is not a concern, nor is the small surface area of the center electrode (Anode).

### Process D: Negative Temperature and Nuclear Fusion Embodiment

In this embodiment, while attempting to equalize temperature with the colder OH in the first chamber (28), at >90 K (−182.97° C.), the oxygen undergoes a liquid phase transition, and at >77 K (−195.8 C), the nitrogen undergoes a liquid phase transition. In practice, these phase changes can take place at higher temperatures if a pressure greater than 1 bar atmospheric pressure exists in the reactor unit (18) first chamber (28). The de-pressurization in the first chamber (28) causes an inrush of air through (but is rate limited by) the narrow section/second chamber (26), such as the equalization of temperature between the first and other chambers is rate reduced. While the OH is colder than the air undergoing condensation, during the condensation phase transition, the air in the first chamber (28) cannot transfer any heat to the OH. In concurrence with these transient temperature and pressure equalization events, the circuit has gained frequency equal to the current rate increase via constructive polarization events, while the OH has reduced frequency such as equal to the U energy transferred during the constructive polarizations to the inductor because it has not been re-heated by the air.

Following the failure of the Air to reheat the OH, the potential difference is re-established between the electrodes. As with previous events, the movement of the polar electrons facilitates but precedes nuclear motion. However, on this occasion, the inversion of the original frequency relationship between the circuit and the OH means that before V1 nuclear motion, the back EMF results in the circuit electrodes changing polarity. In an embodiment, this is a pivotal moment in the evolution of the reaction because the OH develops a truly negative temperature. If there has been zero V1 (nuclear) movement between internal polarization current events, then the last freedom of the OH movement has been arrested.

In one embodiment, the external e-field transfers energy to the polar electrons (enabling polarization and V1 expansion), but before the OH nuclei move (consuming potential energy), the energized inductor (10) (resonant transformer) produces back EMF. The electrodes reverse the internal polar e-field, so return the polar electrons to the OH contraction configuration, with the result that vibrational movement is arrested.

The thermodynamic outcome of such an event sequence can be understood from the following. The result of the circuit having a higher frequency than the OH V1 motion means that the OH volume's entropy peak has been exceeded because it cannot conserve U energy as nuclear motion. The negative temperature OH transfers heat to the cold but positive temperature liquid O2 and N2. As they undergo the forward phase, they change to hot gas in the volume-restricted first chamber (28), so the OH (having lost nuclear U energy) is compressed by the expanding air gas. The fusion or transmutation of the OH to Fluorine is the consequence of the following:
Reduction of remaining internal potential energy via emissions which, by conserving U energy, must include nuclear potential energy, responsible for coulomb barrier forces; and
Increasing external pressure, opposing the reduced coulomb barrier force between each molecule's constituent nuclei.

The inevitability of the result obtained can be understood by the magnitudes of the energies and pressures involved in the reaction.

### Magnitudes of ‘Pumping’ and ‘Dumping’ of the OH Energy

Referring to FIG. 9 where it was visualized that the current is equal to the constructive summed value of both the internal polarization e-fields of the OH series and the external e-fields of the circuit. Wherein during the collision phase of the reaction, the constructive current energy, which is conserved in the V1 motion as increased amplitude, was transferred to the matter (O2) between the electrodes (8, 9). However, once the H2O and O2 molecules are transformed to OH, the constructive current does no work between the electrodes, and because of increased OH volume, the constructive current is increased.

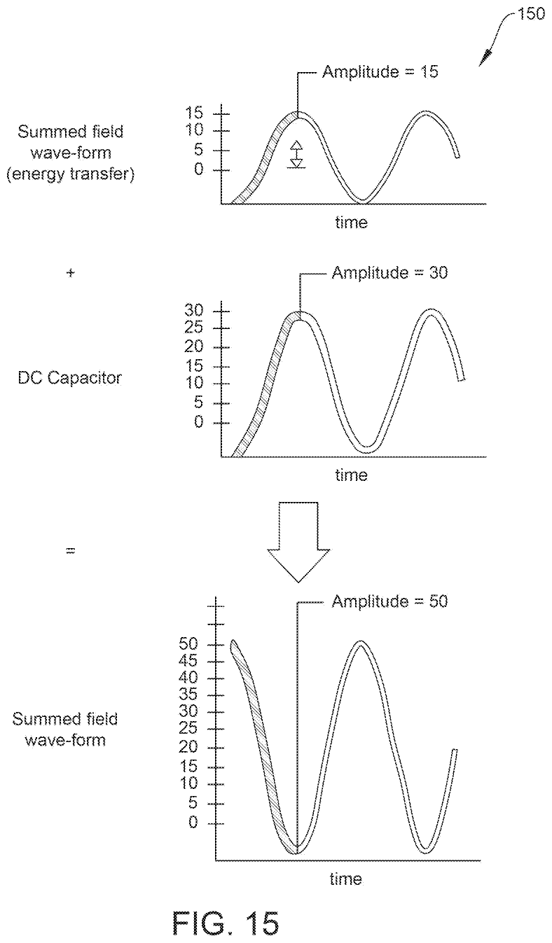

FIG. 15 illustrates a wave diagram (150) showing amplitudes of summed field wave formed and the DC capacitor resulting in the total value of the summed field wave formed. Further, as illustrated in FIG. 15 and by recalling that the polarization of the OH electrons precedes atomic movement. In this case, the summed current flows undiminished to the resonant transformer (11-12) and inductor (10). The OH contribution to the summed value includes the energy that facilitates the movement of the atomic masses.

The resulting waveform, as shown, is inverted because the increased current through the inductors (10, 11, 12) produces back EMF. The actual voltage induced by the resonant transformer (11, 12) and inductor (10) is increased by 10× or more, as shown in oscilloscope graph (200) in FIG. 20, and applied to the OH, which restores the polar electrons to the location required for V1 contraction while providing force in opposition to expansion. In context, the constructive current period is responsible for pumping the OH polar electrons (already containing sufficient potential energy to facilitate movement of the atomic masses) to higher potential energies. Then before the nuclear masses can move (due to low frequency=low V1 temperature), the constructive current energy is conserved in the inductor, which induces a voltage (e-field) in opposition to vibration movement, so ‘dumps’ the potential energy via emissions as the (theoretically) momentarily stationary OH, having negative temperature and entropy, transfers its remaining U energy to the positive temperature and entropy ‘liquefied’ air-gasses. From the above description, it is apparent that the emissions include the potential energy that the OH requires for movement because the emissions occur before movement.

### The Magnitude of the Pressure Acting on the OH and Resistance to that Pressure

This section provides the reason why the magnitude of the pressure acting on the OH is so great, whilst resistance to that pressure is so small. For example, the density of air/nitrogen is approximately 1.2 kg/m3. Hence the volume changes when liquid nitrogen becomes gaseous nitrogen is 900/1.2=750 x. This does not include any additional heating of the N2 following the forward phase transition. The physical model (shown in the calculation section) indicates that the original air volume in the first chamber (28) has condensed by approximately 750 times (during partial temperature equalization with the OH). The narrow section, such as the second chamber (26), reduces the rate of the air in the first chamber (28), and the air in the remaining volume can equalize the temperature. This equalizing of temperatures enables the first chamber air contents to condense.

The intermediate event preceding or simultaneous with the liquid gas transition is the ‘in-rush’ of air (via the narrow section, such as the second chamber (26)) from the remainder of the device to fill the void, such as low-pressure first chamber (28) and is the cause of the dip in pressure as can be seen in the accompanying pressure graphs (refer FIG. 29 onwards). Then finally, during the forward phase transition to the gas state, the OH emissions super-heat the N2 and O2 (and in-rush air) as the OH releases most (if not all) of its remaining potential energy. The flow-restricted narrow section (second chamber (26)) now acts to maintain the pressure increase as the OH fuse to Fluorine.

### Process E: Magnetic Field Method Embodiment

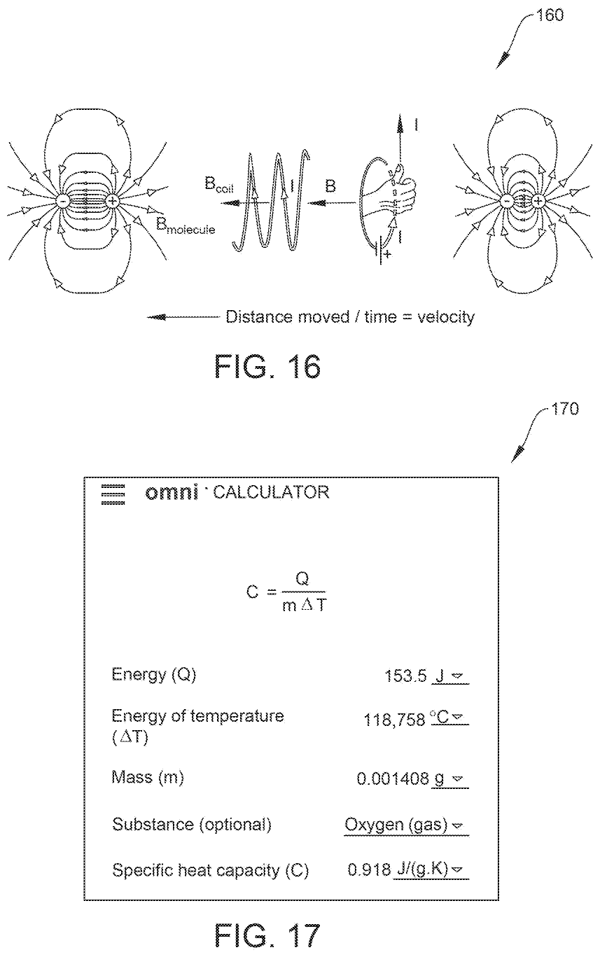

This embodiment discloses as the fused contents of the first chamber (28) are heated and expanded; they are forced into the magnetic field generated by the same current flowing through the solenoid coils (20, 21) as the water-plug second reaction electrode set (9). such as the solenoid coil (20) is in series with the water-plug second reaction electrode set (9). Therefore, its inductance contributes to the total inductance of the circuit. Each molecule's magnetic dipoles are aligned with the external magnetic field as the freedom of movement is restricted to V1 while U energy is conserved in the remaining vibration. The molecules also have kinetic energy due to the heat and pressure produced in the first chamber (28) of the reactor unit (18) from the primary fusion events causing the contents to accelerate. Further, the polarization means that the general motion (kinetics) of the molecules is constructive with the external field, but the vibrational motion has a destructive relationship because the internal magnetic field at the molecule's poles (B molecule) is, by necessity to form a loop, in opposition to the polarity of the external magnetic field (B coil). In this case, V1 vibration expansion modes are suppressed, and the degree of suppression is equal to the magnitude of the external magnetic field (shown in FIG. 16).

FIG. 16 further illustrates (160) that as the molecules (dipolar) move through the external magnetic field, the magnitude of the field is increased, equal to the constructive sum of the external field+molecules velocity. This means that the last remaining (V1) freedom of movement in molecules, in which U energy is conserved, is suppressed by the increasing magnetic field. The molecular contribution to that value is equal to its kinetic velocity (distance moved or displacement over time) through it. This FIGURE also shows that the external magnetic field has a constructive relationship with molecular kinetics but a destructive relationship with molecular vibration.

Regardless of external magnetic field polarization (direction of current through the solenoid coils (20, 21)), the polar alignment of the molecules results in the quenching of their V1 vibration, so the last remaining freedom of molecular movement. The transfer of molecular kinetic energy to the external magnetic field (as induction) is a multi-step process involving conversion to internal energy. The kinetic energy of the molecules is transformed into internal energy at the moment the external magnetic field is increased by their motion through it. The kinetic energy is therefore conserved, in part as work done (induction of a greater magnetic field) and in part as an increase in internal energy. At this point, it is considered that because the external magnetic field already existed, the transfer of kinetic energy from the molecules to this magnetic field means the external magnetic field must conserve more energy than the molecules.

This increase of internal energy (U) is manifested in the molecules only as an increase in potential energy because V1 (dipole movement) motion is suppressed by the increased external magnetic field. While the molecule's potential energy has increased, the ability to express the increase as temperature (V1 motion) has reduced. A negative temperature is achieved because the magnetic force opposing the vibration has increased by a greater magnitude than the internal energy conserved in the vibration. Once the negative temperature molecules (as shown via induction) meet the positive temperature air in the first chamber (28), the heat (U energy) is transferred to the air, and the air is super-heated and expanded, exerting pressure on the nuclear energy depleted molecules, which fuse together and release mass energy as heat.

### Reproduction of Nuclear Fusion Again via the Magnetic Field Method Embodiment by Employing Simple Fluid Dynamics

The increase in the heat and pressure in the first chamber (28) of the reactor unit (18), resulting from primary and secondary fusion events, means that the molecules enter the second chamber or narrow section (26) and accelerate before being expelled into the third chamber (25), where they encounter another external magnetic field created by circuit current through another coil, wired in series with the first coil again adding to the total circuit inductance. From this embodiment, it can be understood that if the velocity of the molecules were to be increased, then the magnetic force (equal to the constructive sum of the external magnetic field plus velocity) suppressing V1 motion also increases at greater than equilibrium with the gain in U potential energy (as before) .such as, This fluid dynamics exploitation enables both: Transformation of greater kinetic energy to greater U potential energy (pumping up in laser parlance) and even greater restriction of V1 motion (negative temperature), as shown in FIG. 14.

The by-product of the increased induction of the circuit results in greater power gain. As the accelerated molecules leave the high-speed, low-pressure region of the second chamber or narrow section (26) and enter the low-speed, high-pressure region of the third chamber (25), they induce the external magnetic field and V1 vibration (conserving ‘greater’ U energy) is suppressed as the molecules develop a negative temperature. Then, as their velocity is reduced (due to ‘increased’ induction), they contact the positive temperature ambient matter (air) in the high-pressure region. The nuclear potential (U) energy is released, the air is heated, and pressure is applied to the energy-emitting molecules, which fuse and release mass energy as heat. (See FIG. 14).

In addition, the increased rate of circuit current (power gain) is conserved in the following cycles of the reaction in both the e-field and magnetic field process method embodiments. It should be apparent that further fusion events can be realized from the same discharge of the circuit (due to the dynamic power gain) if other narrow expansion sections with more coils are added downstream of the third chamber (25). So, reproducing the chamber (26) and (25) layout. The advantage of adding additional chambers and coils results in an increase in the overall efficiency of the device (100) such as circuit energy versus fused product volume and generated heat.4

### Temperature Calculation

A device (100) has a negative temperature when its entropy decreases as its internal energy increases. Considering two molecules that can occupy two energy levels lower and higher. When most of the molecules are in the lower state (as occurs in nature), the system has +ve entropy. As the system increases in temperature the change in energy means that some of the molecules are in lower and some are in the higher states. This system has a positive temperature and while increasing the internal energy, the entropy continues to increase. When the system has 50-50 molecules in the higher energy state, they have reached the entropy limit. Beyond the entropy limit (such as more than 50% of the molecules in the higher energy state) the population is said to be inverted, and any further gains in energy results in a further reduction in entropy and temperature. The transfer of energy from the air to the circuit via the OH is a key component in the

method embodiment, and this invention provides evidence using independent test measurements that validate the method embodiment as described. If the pressure and temperature of the closed system were reduced, then energy must have been removed from that system. The only interface the closed system has with the world outside it is the electrical circuit.

The general thermodynamics that causes condensation of the air can be calculated using the tools such as Specific Heat Calculator, OH (Hydroxyl) specific or latent heat calculator, calculator for calculating equilibrium mixing temperature, and temperature and pressure calculator available the over web. Examples of calculators can be found at https://www.omnicalculator.com/physics/specific-heat, https://webbook.nist.gov/cgi/cbook.cgi?ID=C3352576HYPERLINK “https://webbook.nist.gov/cgi/cbook.cgi?ID=C3352576&Mask=1”&HYPERLINK “https://webbook.nist.gov/cgi/cbook.cgi?ID=C3352576&Mask=1”Mask=1, https://planetcalc.com/7129/ and https://www.omnicalculator.com/physics/gay-lussacs-law.

Using the calculator, it is calculated how much energy 0.05 grams of H2O at 20° C. has been stored prior to the reaction, wherein liquid H2O specific heat capacity=4181.3 j/(kg K). It requires approximately 4.1813 joules of energy from the sun to heat H2O (ice) to liquid (at 20° C.) and 0.05 grams of H2O to 293.15 K (20° C.) where it is conserved in 9 degrees of freedom movement. Further, in the reaction, the H2O molecules are aligned. The degrees of freedom reduces to 1 and the heat capacity gets reduced nine times (=464.59 j/(kg K)), wherein its latent heat is expressed as apparent energy.

Further, the temperature of H2O in the remaining degree of freedom motion is calculated. 20° C.×9=180° C.=453.15 KU Energy is still equal to 4.1813 J but is expressed as increased vibration amplitude in the remaining freedom=temperature=453.15 K. During a constructive period (summed constructive field), the internal energy (4.1813 J) +circuit energy (149.3J)=153.5 J (H2O apparent energy) is transferred via collisions with O2. The entrapped O2 volume is 0.001408 g at 6.8 Bar (100 PSI) gauge pressure), O2 temperature is calculated if the H2O apparent energy is transferred and conserved in the O2 Oxygen. The specific heat capacity of O2=0.918 J/g K, O2 initial temp=293.15 K, O2 change of temp.=118,758° C., O2 final temp=119,051.15 K (118,778° C.), hence the excited and ionized monatomic O1 state following H2O -O2 collisions. This can be calculated using an omni-calculator (170), as shown in FIG. 17. The Omni-calculator is a web-based platform that provides a collection of many online calculators and conversion tools for various purposes. It is used to help users in performing quick and easy calculations, make informed decisions, and solve everyday problems.

It was assumed that a percentage of energy is conserved as O1+O1 motion and the remaining as light emissions. Emissions+collisions=153.5 Joules, which for ease of calculation are completely absorbed by the H2O, so forming a volume of OH+H which is 293.15 K (assumed).

As discussed earlier, the heat capacity of the H2O has been reduced by 9 times to 464.59j/kg K at the time of external e-field energy transfer. Further, a forward phase transition (liquid—gas) can be induced with 9× less input energy than normal and according to the present invention, thermal dissociation in terms of the second law of chemical thermodynamics, the energy required to induce dissociation is also reduced by the same degree. The device of the invention alludes to an increase in temperature of the initial state resulting from reduced heat capacity as being instrumental in the dissociated product volume vs. input energy required. Such as, when the hidden energy becomes apparent, the form it takes can either contribute to a forward phase transition (state change) or dissociation of the parent molecule into daughter fragments of smaller mass.

The known data depicting the energy required for the dissociation of the water molecule is as follows: a) Dissociation of the HO—H bond of a water molecule (H2O) requires 497.1 KJ/mole and 0.05 g=0.00278 moles×497.1=1.3819 kJ=1381.9 Joules energy. Therefore 1381.9 J of energy is required to dissociate the entire 0.05 g volume of H2O to OH+H. b) The estimated specific heat capacity of OH=(approx.) 1125.7 J/kg K, due to having 6 degrees of freedom. The estimated specific heat capacity of air at 100 PSI (20° C.) mostly dry is=1012 J/kg K.

In one embodiment, an assumption is made that 1381.9/9=153.5 joules of energy are required to partially dissociate the entire H2O volume to OH+H if the volume's apparent energy was already 9 times greater as the product of its heat capacity being 9× lower in its remaining freedom of movement (on the X-axis between the electrodes). So, 153.5 Joules of energy is required for 0.050 grams of H2O to produce an equivalent volume of OH+H from the collisions (as the H2O and entrapped O2 volumes are reduced to zero).

An embodiment of the invention also calculates the OH+H volume produced under the normal circumstances of circuit energy being added to the system. In one example, 149.3 joules (circuit)/1381.9 joules=0.10804×0.05=0.0054019 grams of OH+H have been produced. Observing this volume of OH is not required to exist in a reduced heat capacity state for equilibrium to persist in the system. Upon formation, the OH volume is aligned by the external field, so its heat capacity on the x-axis is reduced from 1125.7 J/kg K (conserved in 6 degrees of freedom) to 187.62 J/kg K (conserved in 1 degree of freedom). Further, its temperature in the remaining freedom of movement is increased by a factor of 6, whereas temperature in all other axes is reduced 6 times but heat capacity on those axes is increased 6 times.

An embodiment of the invention discloses the temperature difference between the OH and the air in the first chamber (28) of the reactor unit (18) if the OH volume is only communicating ⅙th of its temperature with the air. In this embodiment, the air mass is 0.01827 g (approx. 1.95 cc)=0.0010142 moles, the OH mass is 0.050 grams, and the OH temperature is on the X-axis (between the electrodes). Where the degree of freedom is 1, the temperature is 293.15 K×6=1,758.9 K. Further, the OH temperature (on all other axes) where the degree of freedom in the final is 1/6th, is 293.15/6=48.86 K. (−224.29ºC). Therefore, on all other axes, the OH specific heat capacity is also 6× greater=1125.7 J/kg K×6=6754.2 J/kg K and the difference in temperature between the air volume and OH volume in the first chamber (28) is 293.15−48.86=244.29 K.

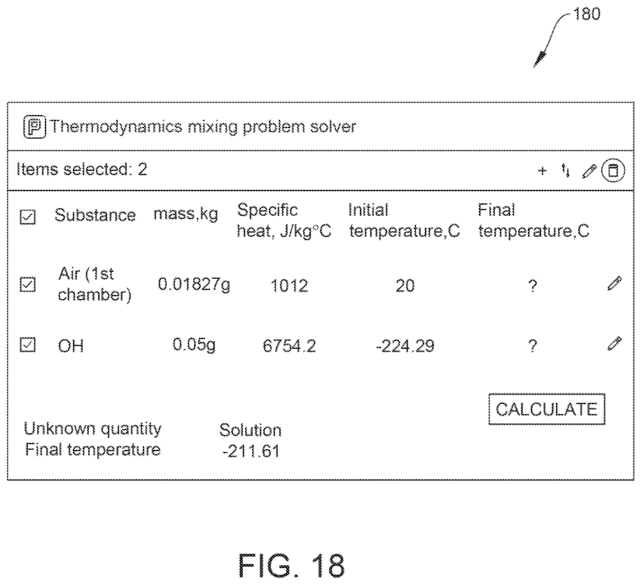

In an embodiment, the mixing temperature between the air and OH in the first chamber (28) is calculated using conventionally known calculators such as thermodynamics mixing problem solver (180). This example was found to be −211.61 Celsius=61.54 Kelvin, as shown in FIG. 18.

The final reaction sequence includes:
1. The back EMF at the electrodes removes the last remaining V1 freedom of movement and the OH achieves hotter than infinite temperature.
2. Heat is transferred from the air to the OH at approx. 90 Kelvin and at 77 Kelvin (higher temps. at greater pressure) and the oxygen and nitrogen (respectively) forming the air volume of the first chamber (28), condensed to the liquid state and contact with the OH.
3. The liquid O₂ and N₂ phase transition to a super-heated gas, due to OH potential energy release.
4. The OH fuses to Fluorine.

A reasonable calculation and evidence (other than the fused product) were provided to corroborate the method of the invention where an independent test conducted by SciTek Ltd. (UK) as mentioned, where the de-pressurization of the air in the semi-isolated volume was measured at −6.369 PSI preceding the fusion event. To have reduced the pressure of the remaining air volume, the temperature of the first chamber (28) should have been reduced during the reaction. Lowering the temperature causes the gas molecules to slow down, resulting in decreased kinetic energy and reduced force exerted by the gas on the chamber's walls, leading to a decrease in pressure. The present invention also utilizes the same variable values as the model but includes the 6.369 PSI depression in the calculation.

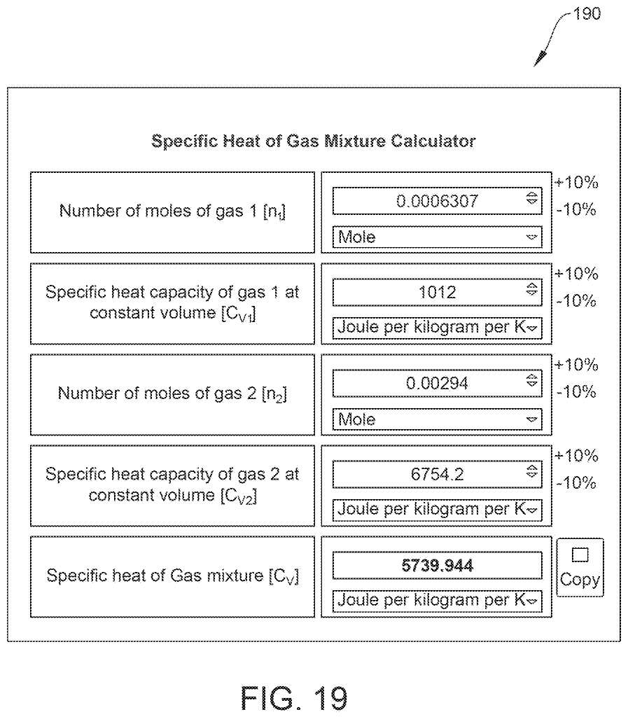

Comparison of the temperatures achieved in the ideal model with an independently conducted test—SciTek Ltd. UK provided the following data. Test 11 (*RM2) is made to find the mixing temperature between the first chamber (28))(−222.98° C. and the remaining air volume and further find the average specific heat capacity of the OH and air. The air mass in the first chamber=0.01827 g=0.0006307 moles and the air-specific heat capacity=1012 j/kg K OH mass=0.05 g=0.00294 moles. OH, specific heat capacity normally is=1125.7 J/kg K However, with V1 movement restriction, on all but the X-axis, heat capacity is increased 1125.7×6=6754.2 J/kg K. The Average total specific heat capacity of the first chamber (28) was found to be=5739.944 J/kg K. If the OH=0.05 cc, the air in the first chamber (28)=1.95 cc, the remaining volume=48 cc, then it is needed to calculate the air temperature in the remaining 48 cc volume, equal to the 6.369 PSI depression at 276.84K=3.69° C. temperature. For all these calculations calculators like specific heat of gas mixture calculator (190), as shown in FIG. 19, and Omni-calculators (170), as shown in FIG. 17 are used.

Further, the mass of the air in the remainder of the volume (including a narrow section of the second chamber (26) and combustion chamber was found to be =48 cc)=0.44976 g. If 114.5 PSI (100 PSI gauge)=293.15 K (20° C. then 108.131 PSI (93.631 PSI gauge)=276.84 K (3.69° C.), 293.15 K−276.84 K=16.31 K reduction in the remaining air volumes temperature, as shown in FIG. 27 and denoted as (270).

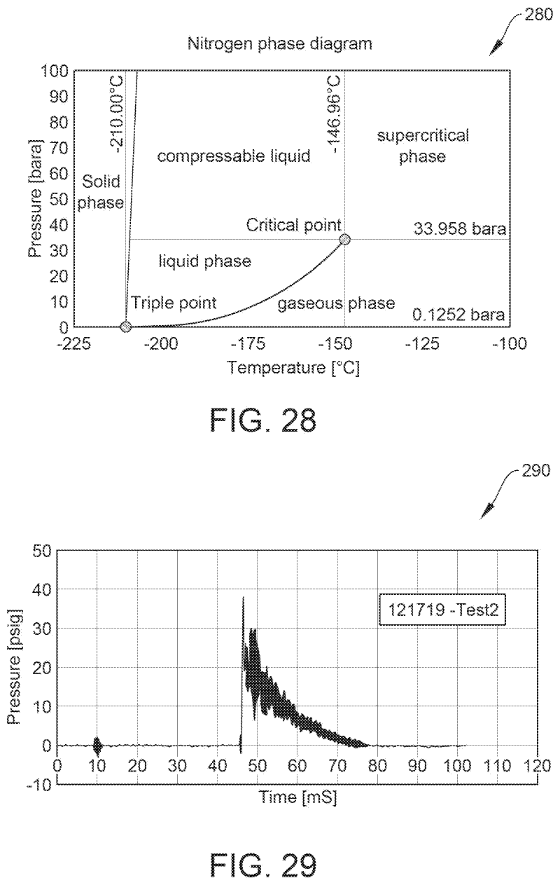

From this information/calculation, the mixing temperature between the First chamber (28) and the remaining volume was found to be −185.74 C=87.41 K. The discrepancy in the First chamber (28) temperature between the ideal model and the calculation based on the actual test was found to be 25.87 Kelvin. This variation was primarily due to not all H2O being converted to OH. When the circuit energy is factored into the equation (80.9 Joules ‘test 11’ vs. 149.3 Joules ‘model’) and the heat capacity of humid air is accounted for, the discrepancy is reduced to zero. However, −185.74 C=87.41 Kelvin. Further, 87.41 Kelvin is close enough to the nitrogen condensation temperature, to assume that in the actual test, both O2 and N2 had undergone phase transition to the liquid state, as depicted in FIG. 28 denoted as (280).

Test Reaction Measurements

An Oscilloscope graph (200) of a typical reaction is illustrated in FIG. 20, which shows:
1st ½ waveform over 30.0 ns duration shows (a) Destructive period, (b) Constructive period, and (c) Destructive period, conforming to the molecules having a higher (V1) vibration frequency than the circuit frequency. This means the work has been done (H₂O U energy has been conserved as a volume of OH, then OH transfers U energy to the circuit) because the 2nd ½ waveform exhibits greater voltage as the result of diminishing O₂ (resistance) and increasing OH (series voltage) volume.
5th ½ waveform where the ½ wave duration is 20.01 ns. The circuit has increased frequency as the product of the transfer of OH U energy. The ambient air, having re-heated the OH less following work periods (to ever-decreasing temperature) has undergone a liquid phase transition. Unable to be re-heated, the OH V1 frequency is reduced. The OH polar electrons are now in resonance with the circuit. During (d) the constructive current flows at approx. 381.5 kV (x 2*) and energizes the inductor (resonant transformer 11, 12). Prior to the OH conserving energy as movement, (e) the Back-EMF opposes the last freedom of motion and re-polarizes the polar electrons. Further, a negative temperature has been instigated on a molecular level.

The voltage probes require the potential difference to be referenced to the ground, so the voltages measured are ½ actual voltages. The oscilloscope graph (200) of a reaction inside the reactor, as shown in FIG. 20, further shows that an increase in OH volume also increases the conductance over time and a decrease in collisions increases the efficiency of energy transfer to the circuit over time.

### Experimental Pressure Data from Independently Conducted Tests to Calculate Temperature

*RM2 (Test 11) as discussed below the test demonstrates that the energy is transferred from the ambient air to the events within the electric field, then to the circuit during the reaction.

### Excerpt from SciTek Pressure Tests

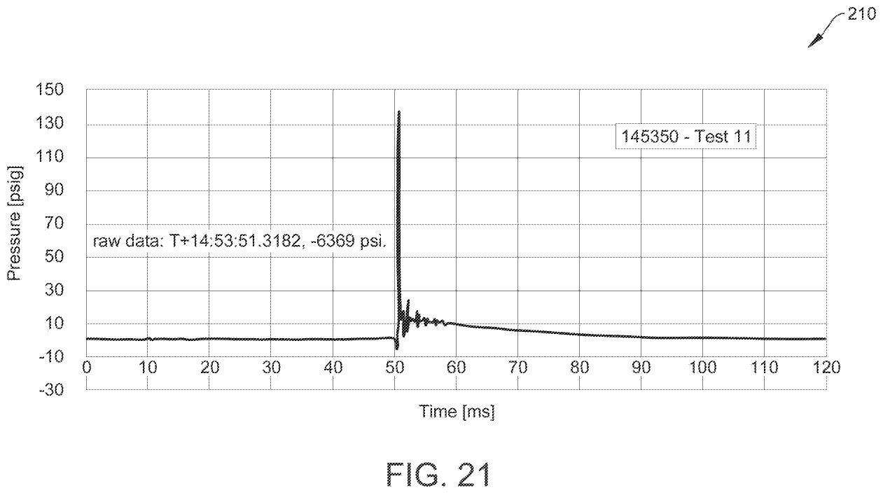

The period over which the temperature is reducing is indicative of a system that is reducing apparent (vibrational heat) energy. Since energy must be conserved and is missing from the system being measured, it must be somewhere else and probably in another form. In one embodiment, the transformation of OH latent heat to apparent heat (as vibrations) when transferred to the circuit as work is done, creates a temperature imbalance throughout the closed system. This is because energy has been removed from the system, as shown (210) in FIG. 21—Test 11 and Table-1).

Independent verification of the dynamic increase in the circuit power—*RM1 test

The test was conducted by the University of Malta where a series of tests to measure the increase in circuit power during a reaction by measuring the time over which the DC capacitor discharge (transfer of the energy stored) was conducted. The initial strategy was to set the prototype up such that the time taken during control events can be measured, where the reaction cannot be instigated (called ‘priming’ in the document), and measure the time taken during productive events, where the reaction proceeds as normal. The fusion resulting in HF combustion is evident as increased pressure in the combustion chamber and movement of the pressure gauges.

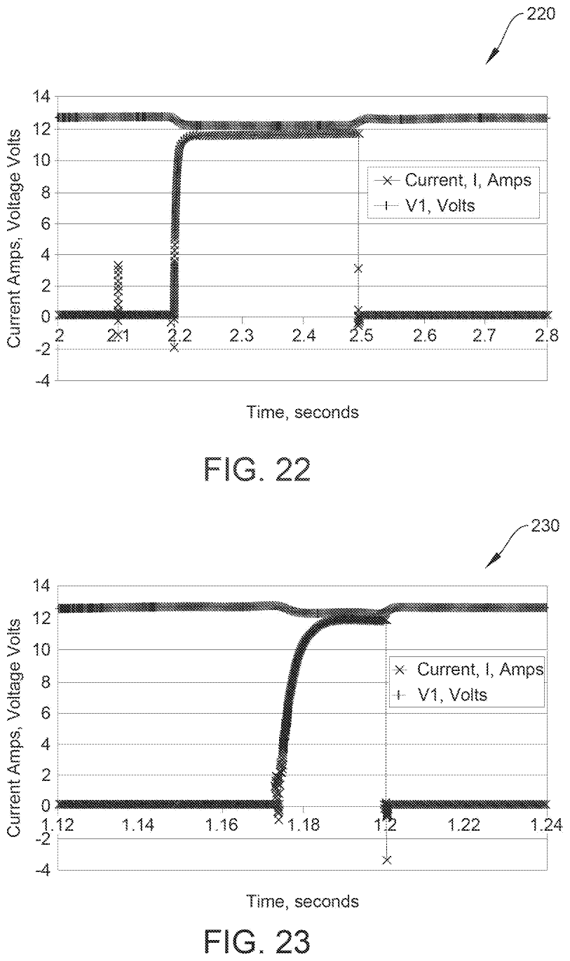

FIGS. 22 (220) and 23 (230) illustrate that during the control event (Log 5), the discharge duration was approx. 0.38 seconds, whereas the duration of the productive reaction (Log 10), was found to be 0.018 seconds. Tests were conducted over a range of DC capacitor charge voltages and consistently demonstrated a dynamic gain in power (rate of transfer of energy) during productive reactions. Therefore, in a preferred embodiment, the DC capacitor can discharge in less than 1 second and preferably less than 0.1 seconds and most preferably less than 0.05 seconds.

Independent Verification Test to Produce Heat/Energy-*RM2

The tests have been conducted by SciTek Ltd. (UK), as requested by the applicant, to deduce the heat produced during the reaction and independently analysis with their calculations. Where the tests were conducted by making variations in the size of the droplet of water from test to test to gather data regarding H2O volume (varied) vs. DC capacitance charge and voltage (constant) in relationship with generated heat (pressure gain in the combustion chamber) and duration of the change in pressure. In the series of tests, the change in pressure during and following a reaction demonstrates that heat is produced as a product of the reaction. In test 11, as shown in FIG. 21 and depicted as (210), the H2O droplets volume was reduced to something approaching an optimum volume. The calculations of all the tests undertaken by SciTek and their results have been provided. The test result shows that the energy input from the circuits is less than the energy out to produce the pressure.

Experimental Results

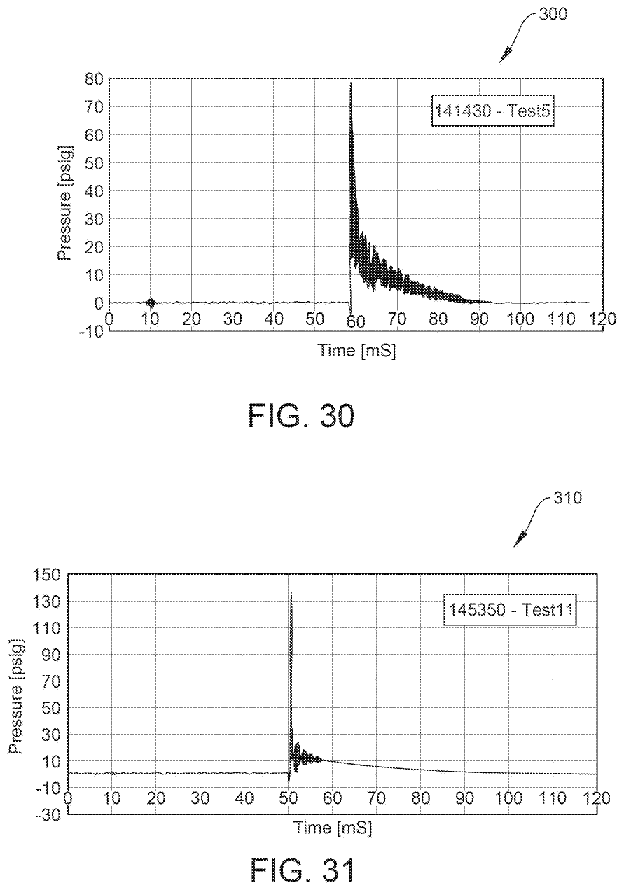

Five experimental tests were used to calculate the energy released by the experiment and the recorded traces of these are shown in the figures, wherein FIG. 29 (Test 2) as denoted as (290) shows maximum pressure of 38 PSIG (pounds per square gauge) and pulse decay period around 35 ms, FIG. 30 (Test 5) depicted as (300) shows maximum pressure 78 PSIG and pulse decay period around 35 ms, FIG. 31 (Test 11) depicted as (310) shows maximum pressure 136 PSIG and pulse decay period around 50 ms. Moreover, the result produced in Test 11 is different from the other four in that the pressure pulse is very high but short-lived and the decay period is much longer at 50 ms but from a pressure level of 10 PSI.

A pressure pulse experimental result shows rapid pressure rise and then an exponential decay of the pressure which is believed to be caused by the dissipation of the generated energy by the mass of air contained within the combustion chamber. In the result, as shown in FIG. 29, or Test 2, it can be observed that prior to the main pressure pulse a very small pressure pulse is present, which takes place 35 ms prior to the main pulse. The decay time of the main pressure pulse lasts for around 35 ms, and the pressure decay also features high-frequency oscillations. It can also be observed that just prior to the main positive pressure pulse there is a small reduction in pressure before the pressure rapidly rises.

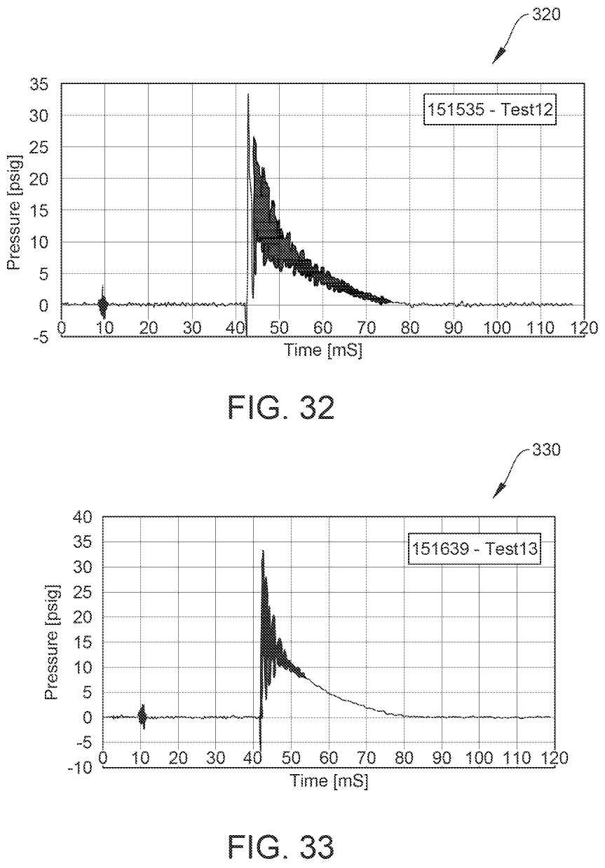

Further, FIG. 32, or Test 12, depicted as (320) shows maximum pressure of 33 PSIG and a pulse decay period of around 37 ms, FIG. 33, or Test 13, depicted as (330) shows maximum pressure of 33 PSIG and a pulse decay period around 40 ms. Out of these five tests, three tests show a decay period of 35 ms, one test shows a decay period of 40 ms, and one shows a decay of 50 ms but from a much lower pressure level. The results are shown in Table 1 below:

TABLE 1
Summary of results and calculations

| | Max | Max | Before | After | Electrical | Calculated |
|---|---|---|---|---|---|---|
| | press | press | discharge | discharge | Energy | Energy |
| Test No | [psi] | [KPa] | [V] | [V] | Input [J] | pulse [J] |
| 121719 | 38 | 262.1 | 887 | 501 | 60.0 | 43.1 |
| Test 2 | | | | | | |
| 141430 | 78 | 537.9 | 887 | 389 | 71.2 | 88.5 |
| Test 5 | | | | | | |
| 145350 | 136 | 937.9 | 887 | 254 | 80.9 | 154.3 |
| Test 11 | | | | | | |
| 151535 | 33 | 227.6 | 887 | 391 | 71.0 | 37.4 |
| Test 12 | | | | | | |
| 151639 | 33 | 227.6 | 887 | 309 | 77.4 | 37.4 |
| Test 13 | | | | | | |

As shown in Table 1, for three tests the energy generated was lower than the electrical energy input and for two of the results, the energy released is higher than the electrical energy input. As two out of the five tests show that the energy released is higher the electrical energy input shows some promise to substantiate the claim of fusion.

Independent Verification Test for the Creation of Fluorine-*RM3

The University of Valencia (Spain) Chemistry department conducted a series of tests to verify the test results. As discussed, one embodiment of the method relies on the transference of energy from the molecules of interest to fuse prior to instigating their fusion. This embodiment proceeded by considering that the neutron emissions produced by other conventional fusion method embodiments were a product of the conservation of momentum of the ballistic fusion partner's huge kinetic energy which is required to penetrate the Coulomb barrier. Much like the force required of a hammer when smashing a rock into fragments, the fragments conserve some of that force. If that force is not required (or at least very reduced), then neutrons cannot be produced in the fusion event. The measurements using a Geiger counter confirmed that there is no excess presence of neutrons during or following the creation of Fluorine.

The conduction of the tests was found safe by the professionals of biological chemistry, and it was confirmed that the tests can be conducted without any added safety precautions. This was because F-17 (isotope of Fluorine) decays via B+ emissions, which under the test conditions is relatively harmless to health. Further, the component suppliers were contacted to confirm that no fluorine existed in the ceramic components, which may have skewed the test results.

Many tests were conducted using normal water O16-H2 and produced F-17, which was measured using two different Fluorine HF meters and litmus tests. The radiation counter metered the half-life decay in accordance with expectations. Further, the reaction was also tested using D2O (heavy water) and produced F-18 (confirmed by the change in half-life decay) again in accordance with expectations. The method embodiments are not limited to the fusion of oxygen with a proton (H) as demonstrated by the D2O test which requires fusion between oxygen and a hydrogen atom nucleus comprised of one proton and one neutron.

Following the validation test series in Valencia a series of internal tests were conducted with the reactor fitted with supplementary solenoidal wound coils (20, 21) to observe the effect of secondary fusion such as, provided the fused product forms a dipolar molecule such as HF, then if the burning HF is required to induce another (or the same) magnetic field, then it fuses (in this case to Neon). Further, the invention also showed very strong evidence that tertiary fusion events are possible within the duration of a single reaction, provided that the ambient pressure is such that molecular reformation rates are within the reaction lifetime. Alternatively, a fused atom product from one discharge reaction may provide the building block for another discharge reaction, etc. thus preventing the production of a variety of exotic or rare elements. In one embodiment, the reaction can be designed to produce a specific element.

### REACTOR EXAMPLES WITH APPLICATIONS

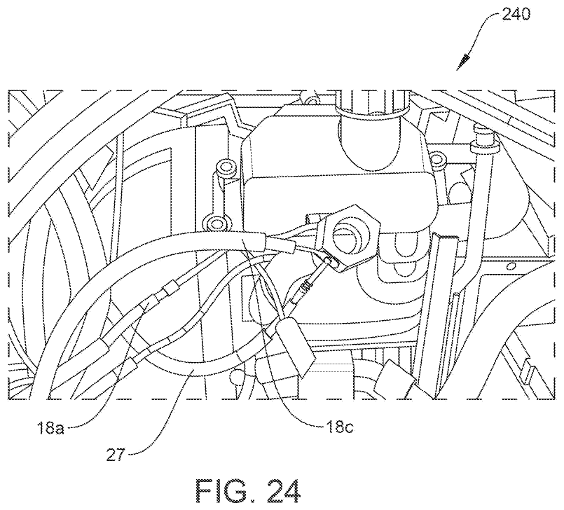

Typical installation of the reactor for generation of heat- In this application, the combustion of the Fluorine with Hydrogen (HF) generates heat to power a twin cylinder gen-set (240), as shown in FIG. 24. In particular, the arrangement of the solenoid coil to the circuit positive connector (18a) and H2O (or other dipolar molecules) injector and check valve (27) is illustrated. It further shows the arrangement/placement of the reactor to the circuit negative connector (alternative arrangement when air-plug first reaction electrode set (8) is external to the reactor unit) (18c). In the figure, a reactor is fitted to one of the cylinders via the engine's existing spark plug aperture, wherein an H2O injector and a check valve assembly (denoted with 30) on the water feed pipe and the solenoidal coil connectors (denoted with 40) are shown. The reaction plug (not shown) is fitted to the reactor unit (18) in the given view. This proof-of-concept test did not utilize the additional efficiency benefit provided by the air spark plug (8) being located inside the reactor unit (18) and described, as the preferred embodiment.

FIG. 25 shows one of the circuits being fitted to the same generator set (250). In this iteration of the invention, one circuit and reactor produce fuel to power one cylinder. The generator set (250) comprises a water tank (252), water pump (254), reactor (251), located in cylinder head one, circuit board (253) for cylinder one, and the location of the Electronics Control Unit (ECU) (255). ECU (255) controls the reaction timing of the reactor (251), water injection timing, and volume through the water pump (254). Further, the second circuit is to be located on the shelf below the one being fitted.

In one embodiment of the present invention, the detection of F-18 can be done using D2O rather than H2O as the reactant. In another embodiment, a reactor unit and circuit prototype were built specifically to produce Fluorine 18 for medical and chemical applications (the prototype used in this test was ‘borrowed’ from the engine).

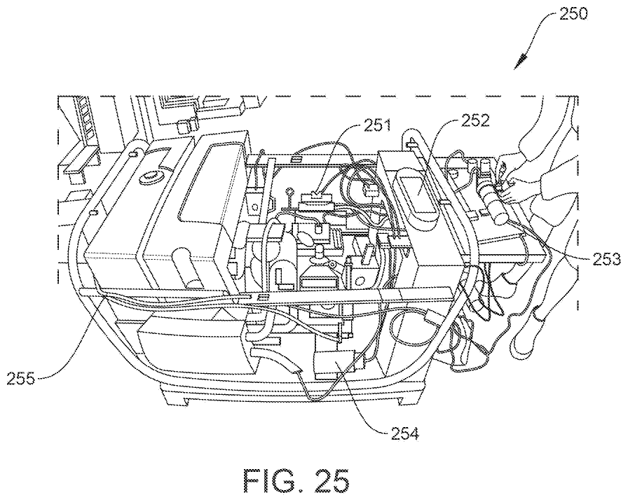

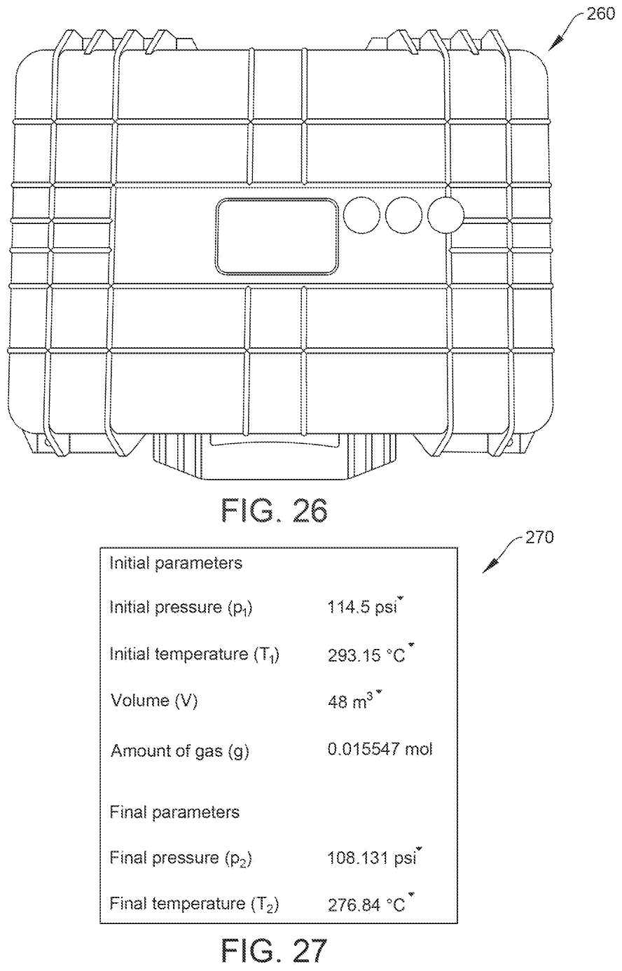

Portable unit for chemical production and medical applications- A dedicated portable prototype was constructed and delivered to the university to undergo evaluation over a series of many test reactions. The report of the *RM3 test is disclosed herein. The device can be small, modular, and portable and requires preferably less than 10 cubic meters, preferably less than 5 cubic meters, and most preferably less than 0.5 cubic meters of space, as shown in FIG. 26. Further, this FIGURE shows the scale of the portable ensemble (circuit and reactor) (260) in the carry case for the creation of elements used in those tests.

Reaction outcomes: Upon ignition, the flame bulb near the reactor occurred later in time than the flame bulb further away. In the test of the invention both causalities such as, circuit induction then fusion as OH becomes F then F bonds with H=HF flame bulb, and their effect such as increased OH volume, leading to a repeat performance in the magnetic field, have been achieved. The more intense flame bulb generated in fusion reaction resulting in higher temperatures.

The ambient pressure tests of the invention demonstrate that even at atmospheric pressure (1 bar), at approx. 20° C. the H2O droplet has been sufficiently saturated with O2 so that alignment of the H2O and its restriction in the freedoms of movement imposed by the reactor electrodes, has still resulted in the production of OH. Further, these reactor embodiments did not have an integrated air-plug first reaction electrode set (8). However, by placing the air-plug first reaction electrode set (9) externally and making the electrode adjustable, although the reaction is diminished overall, the reaction can still be instigated.

The system and method of the present invention advantageously provide an efficient way of heat/energy generation using dipolar molecules to provide alternate renewable energy sources. This system operated in a safe manner and with high energy efficiency and further reduces the dependency on fossil fuels, thereby eliminating the consequences of greenhouse gases. Further, the generated energy acts as a renewable or sustainable energy resource and decreases the environmental impact associated with conventional energy production.

The system allows the efficient storage of energy within the system and potentially enables compact and high-energy-density applications. Furthermore, the practical application of the disclosed system and method during production, operation, or disposal stages was found to be safe and have no major environmental effects. The invention also reduces or minimizes significant loss of energy while converting the energy from dipolar molecules to electrical energy and therefore, increases the overall efficiency of the system.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

Further, the scientific explanations provided in the instant disclosure are based on known scientific principles and aim to offer a rational explanation for the outcome as envisioned using the disclosed system, apparatus, and method. These explanations aim to provide insight into the general principles of the subject invention and the foregoing explanation of the invention describes a preferred embodiment of the invention. These explanations are not meant to limit the scope of the claims. However, a person skilled in the art will appreciate that the present disclosure does not explicitly state that the present invention can be enabled by utilizing solely the components, devices, or equipment mentioned herein and that specific requirements to carry out the invention as shall be appreciated by a person skilled in the art may be utilized without departing from the scope and spirit of the invention.

It is also to be understood that the following claims are intended to cover all the generic and specific features of the invention herein described, and all statements of the scope of the invention that, as a matter of language, might be said to fall there within.

Having thus described the invention in rather full detail, it will be understood that such detail need not be strictly adhered to, but that additional changes and modifications may suggest themselves to one skilled in the art, all falling within the scope of the invention as defined by the subjoined claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. An energy generation device for the selective transmutation of reactive molecules in a reactor comprising:
a. a reactor unit;
b. a first chamber electrically connected to a second reaction electrode set;
c. a second chamber electrically connected to a first reaction electrode set;
d. a third chamber electrically connected to the second chamber, and wherein the first chamber and third chamber being flow connected via the second chamber;
e. an injector configured for injecting dipolar molecules into the first chamber;
f. a primary circuit inductively coupled to the reactor unit via a resonant transformer; and
g. a secondary circuit connected to the reactor unit via the first and second reaction electrode sets.

22. The device according to claim 21, wherein the secondary circuit comprises a voltage multiplier rectifier designed to receive an input voltage from an AC source and provides a predefined DC voltage output to a capacitor.

23. The device, according to claim 21, wherein the discharge of the primary circuit generates a high voltage resonant relationship with the secondary circuit via the resonant transformer, causing discharge of the capacitor, which establishes a high voltage resonant relationship with vibrating dipolar molecules present between the second electrode set, which molecules are aligned according to the potential difference between the electrodes of the second reaction electrode set.

24. The device, according to claim 21, wherein the second reaction electrode set is a water spark plug and the second reaction electrode set is arranged within the reactor unit coupled with the first chamber, where a small volume of dipolar molecules including H2O is to be placed.

25. The device, according to claim 21, wherein the first reaction electrode set is an air spark plug and the first reaction electrode set is arranged either inside or externally connected to the reactor unit, serving as electrodes to be connected to the capacitor via the resonant transformer.

26. The device, according to claim 21, wherein the second chamber of the reactor unit is shaped as a narrow passage between the first chamber and the third chamber.

27. The device, according to claim 21, wherein the third chamber is enclosed by an electrical insulator and preferentially heat-resistant ceramic insulator.

28. The device, according to claim 21, wherein the reactor unit is made of magnetic steel and preferentially magnetic stainless steel and comprises the dipolar molecule injector, and the injector comprises a one-way check valve.

29. A process for energy generation comprising the steps of:
a. receiving a predefined volume of dipolar molecules along with the air in the reactor unit of the device under pressure;
b. introducing high voltage into the reactor unit to dissociate some dipolar molecules of the air-dipolar molecules mixture, resulting in apparent heat generation and production of energized dipolar molecular ions in a single nuclear vibration state along with heated air;
c. transferring the generated apparent heat energy of the heated air via the energized molecular ions to a circuit over at least two cycles;
d. inducing a condensation phase transition of the air within the reactor unit to provide condensed air, wherein the molecular dipolar ions are no longer re-energized by the air, and the circuit develops a higher frequency than the vibration frequency of the molecular dipolar ions;
e. subjecting non-energized molecular ions to a high-frequency electromagnetic field to polarize and repolarize the dipolar molecular ions, wherein the molecular dipolar ions develop a negative temperature and nuclear potential energy is transferred to the condensed air to provide a positive temperature; and
f. expanding the positive temperature condensed air to create a pressure to fuse the energy-depleted dipolar molecular ions to generate energy.

30. The process, according to claim 29, wherein the dipolar constituents of the mixture are forced into an external magnetic field produced by a solenoid coil, which results in an external pressure causing a series of primary, secondary, and tertiary fusion reactions.
